(19) United States
(12) Patent Application Publication
(10) Pub. No.: US 2017/0156364 A1
(43) Pub. Date: Jun. 8, 2017

(54) CARAMELIZED COMPOSITIONS

(71) Applicant: The Hershey Company, Hershey, PA (US)

(72) Inventors: Brian S. BAKER, Millersburg, PA (US); Judith WILLIAMS, Harrisburg, PA (US); Gregory ZERPHY, Elizabethtown, PA (US); David WORTHING, Middletown, PA (US); Jennifer WEIST SCHWARTZ, Hershey, PA (US)

(73) Assignee: The Hershey Company, Hershey, PA (US)

(21) Appl. No.: 15/351,214

(22) Filed: Nov. 14, 2016

Related U.S. Application Data
(63) Continuation-in-part of application No. PCT/US2015/031031, filed on May 15, 2015.
(60) Provisional application No. 61/993,812, filed on May 15, 2014.

(51) Int. Cl. A23G 1/32; A23G 1/44; A23G 1/00; A23L 27/21

(52) U.S. Cl. CPC A23G 1/32; A23L 27/215; A23G 1/44; A23G 1/0006; A23V 2200/15; A23V 2250/1842; A23V 2300/24

(57) ABSTRACT

Described herein are processes and methods of producing a new food confection or ingredient, the food confection or ingredient including a caramelized white chocolate food product. The methods encompass variations in the conditions for a Maillard reaction in order to advantageously select a predetermined combination of flavors and colors of a finished food confection product or food ingredient.

### REFERENCE TO RELATED APPLICATIONS

This application is a continuation-in-part of PCT/US2015/031031, filed May 15, 2015, which is based upon and claims priority to U.S. provisional patent application 61/993,812, filed May 15, 2014, and the entire contents of these prior documents are incorporated herein by reference.

### FIELD OF THE INVENTION AND INTRODUCTION

In one aspect the inventions herein relate to a process for preparing a caramelized food product or confectionary product. In another aspect, the inventions relate to variations in the Maillard reaction used in confectionary methods in order to produce a range of color and flavor options in a final product. We describe a process that produces unique confectionary products that are useful in the same capacity as dark, milk, and white chocolates. The product can have the texture of a chocolate product, a yellowish/gold color, a characteristic flavor of caramel, a flavor component associated with toffee and/or butterscotch, and any combinations of these. One advantageous product includes caramelized white chocolates that can be produced in a number of colors. In some embodiments, chocolate and white chocolate products described herein will fall with the US standard of identity for any of a chocolate or a white chocolate product, filling, coating, or ingredient, yet have a flavor and/or color that can be controllably varied from that of traditional chocolate and other confectionary products.

### RELEVANCE OF THE INVENTION AND DESCRIPTION OF RELATED ART

The Maillard reaction is well known in the cooking and confectionary arts. Minifie (Chocolate, Cocoa, and Confectionery; 3d Edition, Aspen Publishers, 1999) refers to the reaction in both the fermentation of cocoa and the production of caramel and the specialized Maillard reactions for caramelization of milk solids, water and sugars. The Maillard reaction is a complex, but common, reaction in foods traditionally used to develop certain flavors and colors. The two main components necessary for the reaction to occur are protein and a reducing sugar. For some confectionary products in particular, milk is a common food that naturally contains protein (whey and casein) and a reducing sugar (lactose) and thus can be used itself in the reaction. The Maillard reaction of milk powder in chocolate is responsible for developing caramelized flavors that are characteristic of many European-style chocolates. However, the rate of the reaction and the final product color and flavor due to the Maillard reaction is greatly affected by the conditions used, such as the temperature and times at temperatures for different steps in the process.

The prior art teaches that the Maillard reaction is to be intentionally and desirably avoided in white chocolate processing and manufacture. The teachings herein present surprising results that teach away from that long-standing practice and belief among food scientists.

### SUMMARY OF THE INVENTION

In one aspect, the inventions herein provide new and advantageous methods and processes for making a variety of caramelized confectionery products. In another aspect, the methods and processes allow the confectioner to adjust the color and/or flavor profiles of caramelized products in order to design, create, and produce targeted properties. In another aspect the inventions herein include new and non-obvious modifications to the Maillard reaction used in confectionery production.

In an example, described herein are methods of producing a caramelized white chocolate-derived food product (such as a confection) comprising mixing a milk protein source and a sugar source, optionally adding cocoa butter, heating the resulting mixture to greater than 180° F., or greater than 200° F., or about or greater than 220° F., for a selected amount of time and optionally under constant agitation, followed by cooling the mixture. Alternatively, the caramelization process can be at a lower temperature, approximately 40-50° C., for extended periods of time, ranging from several hours to days. In another example, described herein is a caramelized food product or confectionary product made by heating white chocolate, such as a standard of identity white chocolate or a white chocolate ingredient, cream, coating or filling, which can be referred to as a white chocolate-type product or white chocolate-type food product, to a temperature greater than 180° F., or greater than 200° F., or about or greater than 220° F., for a selected amount of time optionally under constant agitation, followed by cooling. This results in a caramelized food product, or in this example a caramelized white chocolate-type food product. The characteristics of the food product are determined by the variation in the time and temperature selected.

In a preferred embodiment, the food product contains caramelized flavor and color components as a result of a Maillard reaction between the proteins and sugars present, however the food product can lack detectable amounts of the flavor component 2-hydroxy-3-methyl-2-cyclopenten-1-one, which is present in some prior art caramelized confections. Alternatively, the food product can lack detectable amounts of both 2-hydroxy-3-methyl-2-cyclopenten-1-one and 2-methyl furoate. In one example, the selected amount of time at temperature is from about 10 minutes to about 80 minutes. In another example the selected amount of time is longer than 30 minutes. Also as noted in the examples, the preferred heating temperature is about 250° F., or at least 200° F., or about 220° F. As with other white chocolate type food products, the methods and products of the invention can use about 40-50 wt % sugar or about 30-55 wt % sugar, such as a reducing sugar or combinations of one or more reducing sugars, with or without other sugars and sweeteners. Reducing sugars can be selected from one or more of the following: glucose, glyceraldehyde, galactose, lactose, maltose, ribose, xylose, fructose, maltose, arabinose, aldopentoses, and any other reducing sugars.

In another aspect, the products of the invention include a confectionary food product or ingredient wherein the differential secondary protein structure of the protein present in the product as compared to other white chocolate or caramelized products is detectable as an infra-red (“IR”) spectrum shift in identifiable amino acid side chain peaks, for example. A similar shift in the secondary structure can be observed in other types of products, such as milk chocolates, but is not present in white chocolate. Thus, the invention includes products made, and the process of making them, wherein the spectrum shift in identifiable amino acid side chain peaks is detectable.

In another aspect, methods are provided for producing a caramelized white chocolate type food product containing one or more of the flavor components 2-acetyl furan and 2-acetyl-3-hydroxy furan. As in other aspects, however, the food product can lack detectable amounts of the flavor component 2-hydroxy-3-methyl-2-cyclopenten-1-one, or in addition lack methyl 2-furoate. Food products and ingredients made from the method of heating a white chocolate or milk chocolate starting material to above 180° F. or about or above 220° F. for a selected amount of time and thereafter cooling the product are also specifically included. Other starting materials are discussed below and referred to in the examples, including dairy milk and other milk products.

The food products and ingredients produced from the methods and processes herein can include one or more of a variety of acceptable food grade additives, flavors, or colors, especially those consistent with the white chocolate starting material (“base”) and/or the caramelized flavor and color that are created by the new methods herein. Some compatible additives can include brown sugars, molasses flavors, one or more reducing sugars, and combinations thereof. However, some aspects of the invention specifically avoid the use of brown sugar in the methods and food product, and can also or alternatively specifically avoid using any added coloring agent or any added flavoring agent. The reducing sugar can be selected from any available, but preferred examples include lactose, ribose, fructose, maltose, galactose, and glucose, and other available sugars. Optionally, one or more reducing sugars can be selected from the following: glucose, glyceraldehyde, galactose, lactose, ribose, xylose, fructose, maltose, arabinose, aldopentoses, and any other reducing sugars. As discussed herein and as shown in some of the examples, the invention includes the use of fats, such as cocoa butter. However, any edible fat or a mixture of edible fats could be used, such as but not limited to: cocoa butter; cocoa butter substitutes, replacers, improvers, and equivalents; fats derived from algae, vegetables, and animal sources (sunflower, peanut, corn, wheat kernel, rapeseed, safflower, flaxseed, soybean, palm, palm kernel, canola, cottonseed, milk, dairy milk, shea, illipe, sal, mango kernel, avocado); other edible fats or oils. Similarly, the invention discussed herein and as shown in the examples, includes the use of lecithin or an emulsifier. Exemplary emulsifiers include, but are not limited to: lecithins (deoiled, modified, enriched, fractionated, enzymatically modified, hydrolyzed, hydroxylated); natural lecithins; phosphatides; phospholipids; sugar esters; citric acid esters; sugar ethers; polyglycerin fatty acid esters; sorbitan fatty acid esters; monoglycerides; sorbitan esters; polyglycerol esters; and ammonium phosphatides.

Notably, however, other chocolates such as milk and dark chocolate can also be prepared using the inventions herein, and adding one or more types of cocoa solids is expressly contemplated as part of the inventions herein. For example, cocoa liquor, cocoa powder, and other cocoa extracts and cacao-derived material can be used for this purpose.

In another aspect, the invention preferably uses high levels of lecithin, for example above 0.5% wt, or about 0.7% wt or above for commercial scale processing, and higher levels are possible and can optimize the resulting product. For example, lecithin levels over 1.0% wt., or up to about 2% wt, or 4%, or 8%, or even 10% are possible with the invention. The high levels of lecithin allow the high temperature processing (for example greater than 180° F.) of chocolate. Generally, the literature in the art states that the glass transition (Tg) of amorphous lactose in whole milk powder is 59° C. (138° F.) (see Ziegler, G. R. and Langiotti, J. P. 2003 “Grinding spray-dried milk powder near the glass transition temperature” J. of Food Process Engineering, 26, pp 149-160). When amorphous lactose goes through its glass transition, its molecules start to gain mobility and will eventually crystallize. When this type of crystallization occurs in molten chocolate, very hard agglomerates (˜1-2 mm in size) are formed. The chocolate then needs an additional size reduction steps to break up these agglomerates. U.S. Pat. No. 6,548,099 teaches how to crystallize the amorphous lactose in whole milk powder before size reduction. In the present invention, high lecithin levels, such as above 0.4 or 0.5% wt, prevent crystallization of the amorphous lactose in the milk powder when heated to temperatures above 180° F.

In typical chocolate processing, lecithin is added as late as possible, normally at the end of conching. It is known that exposure to relatively high temperatures for long times reduces lecithin performance (Chevalley, J. 1988; Chocolate flow properties. In Industrial Chocolate Manufacture and Use, S. T. Beckett, ed., pp. 152. AVI, New York). Also, it is well known that lecithin levels above 0.5% wt will make chocolate products more viscous and leads to less desirable texture and mouthfeel in general. Therefore, one of knowledge in the art would not add more than 0.5% lecithin or heat chocolate above 180° F. Contrary to this general practice of the art, the invention here does both or can be used with high lecithin levels and/or high temperatures. In fact, without limiting the invention to any particular theory, the inventors consider high lecithin levels as a factor in enabling the proper heating conditions at the temperatures that result in the flavor components and color profiles noted here, especially for the white chocolate-type food products. The examples below show a variety of natural lecithin ingredients used. In one aspect, the invention is preferably practiced with one or more natural lecithin ingredients, and thus specifically excludes the use of a synthetic lecithin ingredient, such as lecithin YN from Palsgaard AMP 4448. However, as noted above, other lecithins or emulsifiers can be selected and used, alone or in combination.

The methods herein can further include a step to increase the pH of the mixture of protein and sugar or the white chocolate base (starting material), and thus the products can include a pH adjusting component. One such pH adjusting component is disodium phosphate, but other acceptable food grade pH adjusting compounds and mixtures can be selected and used. Products made by the processes herein may optionally include or employ all ingredients that may be used for chocolates, white chocolates and related coatings, fillings, and ingredients that are compatible with, participate in, and/or increase the rate of the Maillard reaction. Such compounds specifically include disodium phosphate, sodium bicarbonate, and sodium carbonate.

Throughout this disclosure, applicants refer to texts, journal articles, patent documents, published references, web pages, and other sources of information. One skilled in the art can use the entire contents of any of the cited sources of information in combination with the teachings herein to make and use aspects of the inventions herein. In particular, the patent documents U.S. Pat. No. 6,548,009 and U.S. Pat. No. 8,137,726 are incorporated herein by reference. Each and every cited source of information in these patent documents are also specifically incorporated herein by reference, in their entirety. Portions of these sources may be included or added to this document as allowed or required. However, the meaning of any term or phrase specifically defined or explained in this disclosure shall not be modified by the content of any of the sources, including the US patent documents. The description and examples herein are merely exemplary of the scope of this invention and content of this disclosure and do not limit the scope of the invention. In fact, one skilled in the art can devise and construct numerous modifications to the examples listed below without departing from the scope of the inventions herein.

### DESCRIPTION OF THE DRAWINGS

The following figures are examples of the scope and content of the invention and are not meant to limit the claims to any particular aspect or embodiment of the invention. The patent or application contains at least one drawing executed in color. Copies of this patent or patent application publication with color drawings will be provided by the Office upon request and payment of the necessary fee. FIGS. 1A and 1B depict exemplary processes for modifying the color and flavor of a white chocolate starting material using the inventive conditions, for example to commence a controlled Maillard reaction as described.

FIG. 2 (color photograph) shows the range of color options produced by the inventors and identified as Hershey 1-5 samples. Two comparative samples (Commercial 1-2) are also shown.

FIG. 3 depicts the results of an exemplary infrared absorbance spectroscopy that shows the content differences between a sample produced by a process of the present invention (labeled as “Hershey Blondie”) to that of a commercial sample (labeled as “Caramac”). A peak at 1740 cm⁻¹ can be used to easily and reliably differentiate the two samples. Samples can be analyzed on Thermo Single Bounce Smart ITR with a diamond cell and using 128 scans at 2 cm⁻¹ resolution, as shown in FIG. 3.

FIG. 4 depicts the results of an exemplary infrared absorbance spectroscopy analysis (from a different wavenumber region than FIG. 3), and showing the content differences between a sample produced using the conditions of the invention (“Hershey Blondie”) compared to commercial samples (i.e., Caramac; Blommer; Valrhona Dulcey). The peak at about 1420 cm−1 for the Valrhona Dulcey sample can be attributed to the amino acid side chains. Without being limited by theory, a Hershey Blondie peak at 1475 cm−1 can be attributed by the inventors to unique amino acid side chains.

FIG. 5 lists the color attributes of three separate batches of confectionary white chocolate products made according to the methods and processes described herein. All were heated at 250° F. In the data, L* represents the lightness (100=white, 0=black); a* represents the position between magenta/red (positive values) and green (negative values); and b* represents the position between yellow (positive values) and blue (negative values). In general, the b* values are used to measure the browning that occurs in the Maillard reaction. The “Time” listed in these charts refers to the amount of heating time after an initial temperature of 110° F. CNT is a control with no heating time. The Pantone is an industry recognized standard useful for color comparison. As noted in the examples below, the change in L* by a decrease in value of one unit indicates the start of flavor and color development. Thus, the time at the selected temperature after this change in L* is detected can dictate the flavor components present in the final product as well as the color of the final product.

FIG. 6 (color photograph) depicts the variability possible using a white chocolate starting material or base product and the conditions for a Maillard reaction as described herein. For the samples shown here, the color continuum is representative of the G5-6 samples in FIG. 5 and the L*a*b* numbers as shown in FIG. 5 for the G5-6 samples taken at various points during 250° F. reaction times (“Time” in FIG. 5).

FIGS. 7-10 show GCMS data for a sample of the invention (“Blondie 6B”) compared to various commercially available samples. Some but not all compounds are identified in the charts, and the differences between the content of each compound in the sample is evident by comparing the top and bottom graphs.

FIGS. 11 and 12 show the content and calculated amounts of four specific flavor compounds in the samples of the invention (e.g. Blondie 6B, 6C, 6E, 12) compared to commercial samples (Valrhona Dulcey, Caramac, Equilibre). As shown, the samples of the invention can contain specific subsets of flavor components that differentiate them from the other samples and from the commercial samples. The sample Blondie 12, as noted above, further contains a brown sugar ingredient, which may be the source of flavor marker 2-hydroxy-3-methyl-2-cyclopenten-1-one (MCP) compared to other “Blondie” or “Hershey Blondie” samples shown, where MCP is absent.

FIG. 13 lists the flavor or sensory descriptions used in profiling the samples as shown in FIGS. 14-16.

FIG. 14 lists the flavor and sensory differences noted between the samples of the invention (Hershey Blondie 6B) with commercial samples. The characteristics with p Values bolded are deemed statistically significant differences.

FIG. 15 shows a flavor star chart comparing the Hershey Blondie 6B samples to commercial samples.

FIG. 16 shows a sensory star chart comparing the sensory characteristics of the Hershey Blondie 6B sample of the invention with commercial samples.

### DETAILED DESCRIPTION OF EXEMPLARY EMBODIMENTS

In one embodiment, methods herein manipulate process times, process temperatures, formulations, and combinations thereof to produce a targeted, desirable food or confection product having a unique combination of caramel flavor, color, and texture. In additional embodiments, those combinations can be applied to foods and food confections as chocolates, coatings, fillings, and related ingredients to create novel food products. For example, the conditions described herein for making a caramelized confectionary from a white chocolate starting material differ in such aspects as temperature and/or time at high temperature compared to traditional white chocolate processing. Further, the methods of the invention lead to products and ingredients, such as white-chocolate products and ingredients that possess measurably different flavor components compared to other caramel-type products.

Thus, in one aspect, the invention involves the manipulation of ingredients and heating conditions useful in a Maillard reaction for confectionary or food products. An exemplified and preferred confectionary product herein begins with a white chocolate base as the starting material. As shown here, the products that result from the reactions and conditions used in the methods herein can, in a predetermined fashion, include and exclude certain flavor compounds, which compounds are readily identifiable such as by GCMS. Furthermore, or alternatively, the novel caramelized confectionary products can possess different protein secondary structures as compared to known commercial products, and can be readily identified and differentiated, as shown by the exemplary IR data herein, which is believed to be attributable to differing amino acid side chains and the peaks that indicate their presence (or absence). Thus, a chemical fingerprint is available and readily detectable for each caramelized food confection made by the processes described herein.

The compositions and products herein can also contain enhanced levels of polyesters or polysucroses as a result of the methods herein. Moreover, various additives from cocoa, such as epicatechin and epicatechin polymers or cocoa polymer compositions, cocoa extracts containing high levels of polyphenols, or similar cocoa extracts, can be supplemented into the products, as well as into product starting materials and other ingredients as part of the invention.

In one aspect, this invention utilizes the Maillard reaction at processing temperatures that are much higher than any conventional chocolate process. This invention includes a process where finished white chocolate is heated well above 200° F. and for a specific amount of time. The ingredients used in this and other aspects of the invention can include common ingredients used in conventional chocolates, white chocolates, confections, and coatings.

This process of the invention is not common to someone knowledgeable in the art. For example, when white chocolate is heated above 180° F., it starts to thicken (gel) due to water release and possibly the denaturation of the proteins in the milk powder. At this point, someone knowledgeable in the art would deem the product unusable. However, without limiting the invention to any particular theory or mode of action, the inventors consider the theory that if the mass continues to heat above 200° F., the sugar combines with the fat to form sugar esters. Sugar esters are known emulsifiers that have viscosity-reducing power in chocolate. Thus, the mass becomes fluid again. Further heating then produces the color and flavor combinations and options to provide a novel food confection.

Changes in the physical characteristics occur during processing which may be quantified with several different analytical techniques, with the results confirming the difference between a product made by this invention and commercially available products, such as Caramac and Valrhona Dulcey.

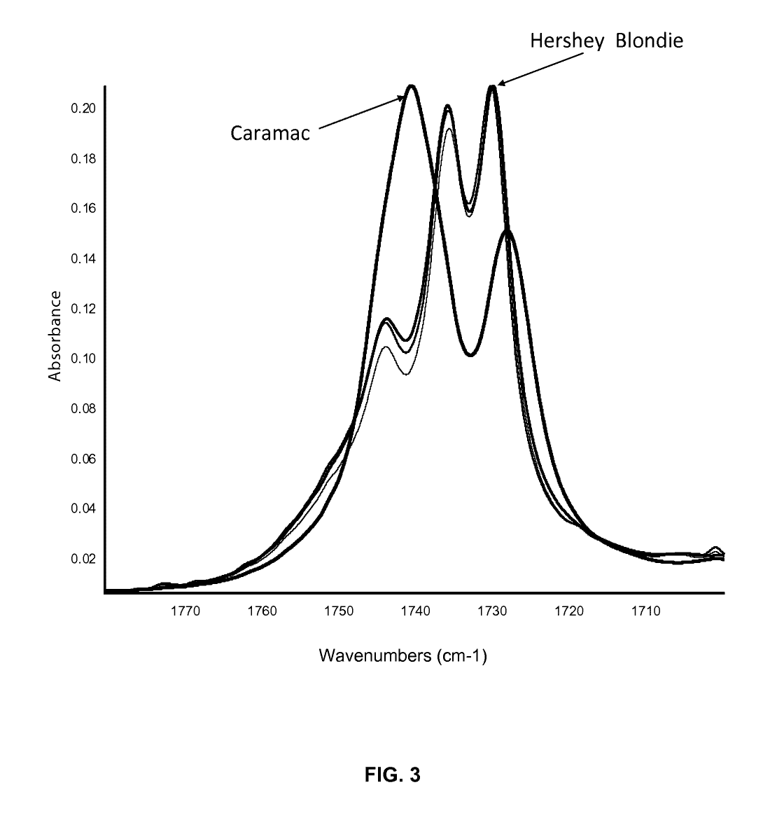

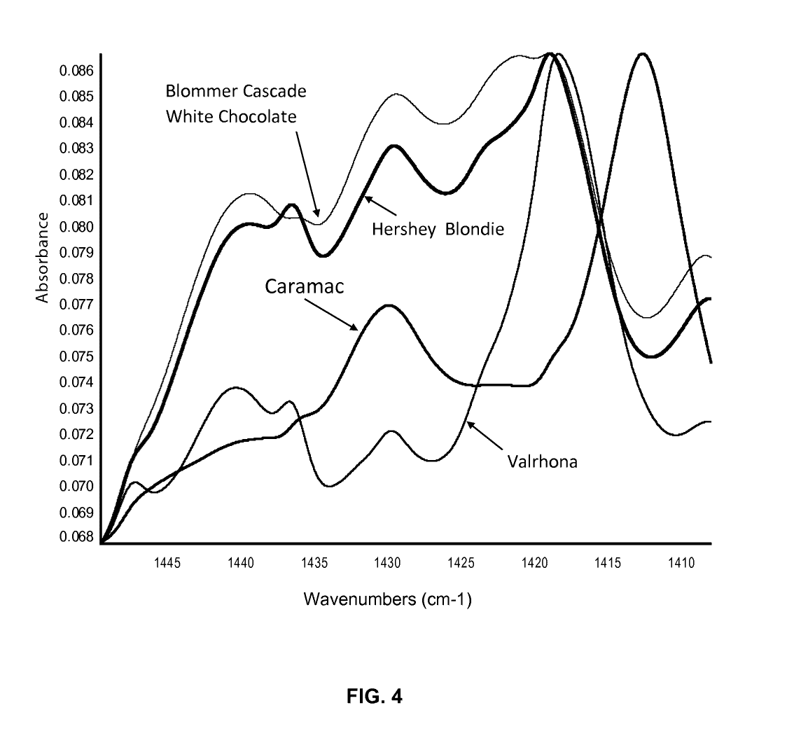

As shown in FIGS. 3-4, a secondary protein denaturation or modification is occurring which differentiates the product made by this invention with commercial Caramac. An examination of the FTIR spectra indicates a difference in the peaks at ˜1740 cm−¹ wave numbers and other regions. This indicates a putative change in the secondary protein structure as these regions refer to the amino acid side chains present in the proteins of the samples.

FIG. 4 shows that secondary protein denaturation is occurring, which differentiates the product made by this invention with commercial product Valhrona Dulcey and Blommer Cascade White Chocolate. A further examination of the IR spectra in the region 1440-1410 cm−¹ indicates differences in the side chain amino acids of the samples with peaks at ˜1420 cm−¹. Additionally, the Hershey Blondie sample of the invention has a peak at 1425 cm−¹ that is also attributable to amino acid side chains. (See Carbinaro, M. Amino Acids 38: 679-690 (2010)).

The term “food product” includes any edible or consumable product that can be ingested by humans or animals to provide nourishment or provide supplements, and includes but is not limited to any type of chocolate foods or ingredients such as chocolate or white chocolate bars, chocolate candies, chocolate drinks, chocolate-flavored foods, chocolate-flavored bars, chocolate-flavored candies, chocolate-flavored drinks, chocolate-coated foods, chocolate-coated bars, chocolate-coated candies, milk chocolate and white chocolate coatings, fillings and the like.

### Examples

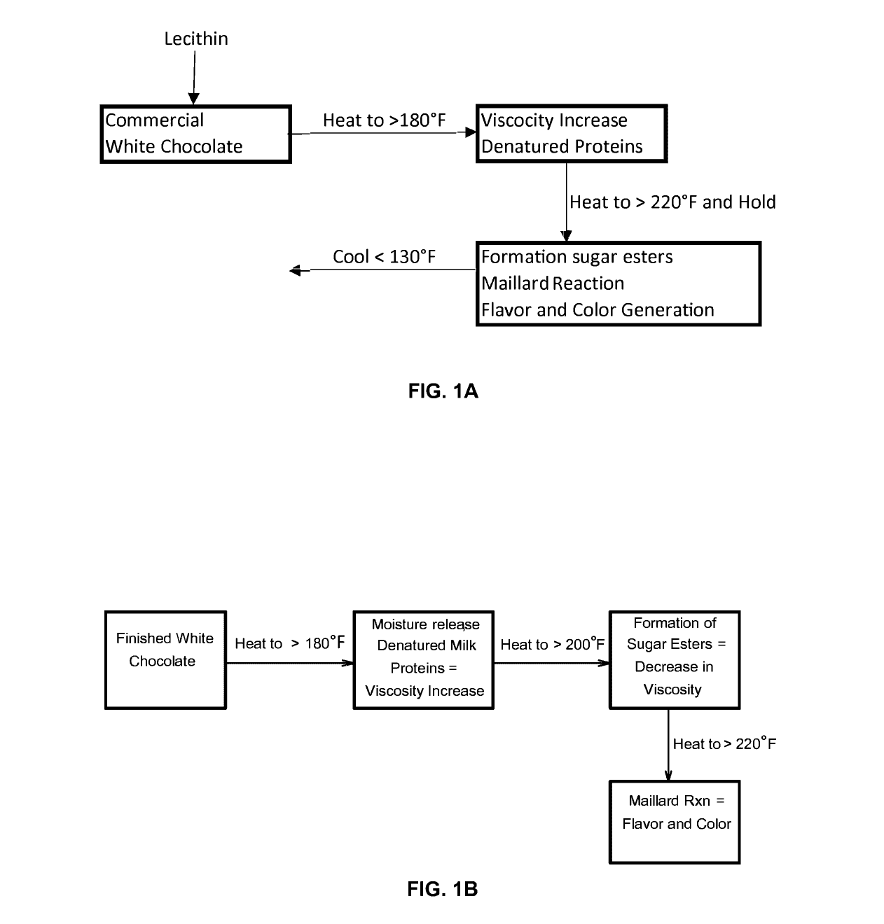

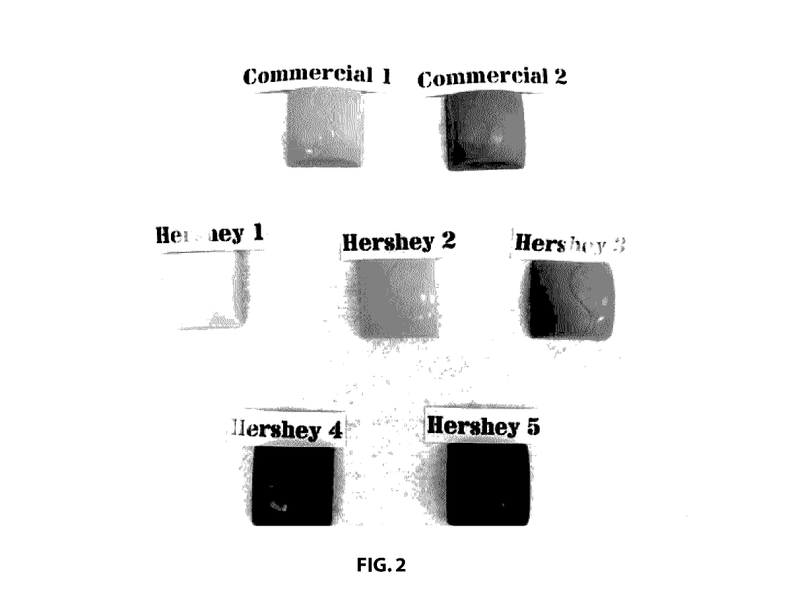

As shown in color photograph of FIG. 2, the color variations in the “Hershey” samples of the invention vary greatly compared to the commercial samples 1 and 2. For these data, white chocolate (sucrose, non-fat dry milk powder, whole milk powder, and cocoa butter) is heated in a scrape-surface kettle using low or medium pressure steam as the heat source. The following conditions can be used:
Hershey 2 heating to 230° F. and held at that temperature for 45 minutes.
Hershey 3 heating to 240° F. and held at that temperature for 45 minutes.
Hershey 4 heating to 250° F. and held at that temperature for 45 minutes.
Hershey 5 heating to 250° F. and held at that temperature for 60 minutes.

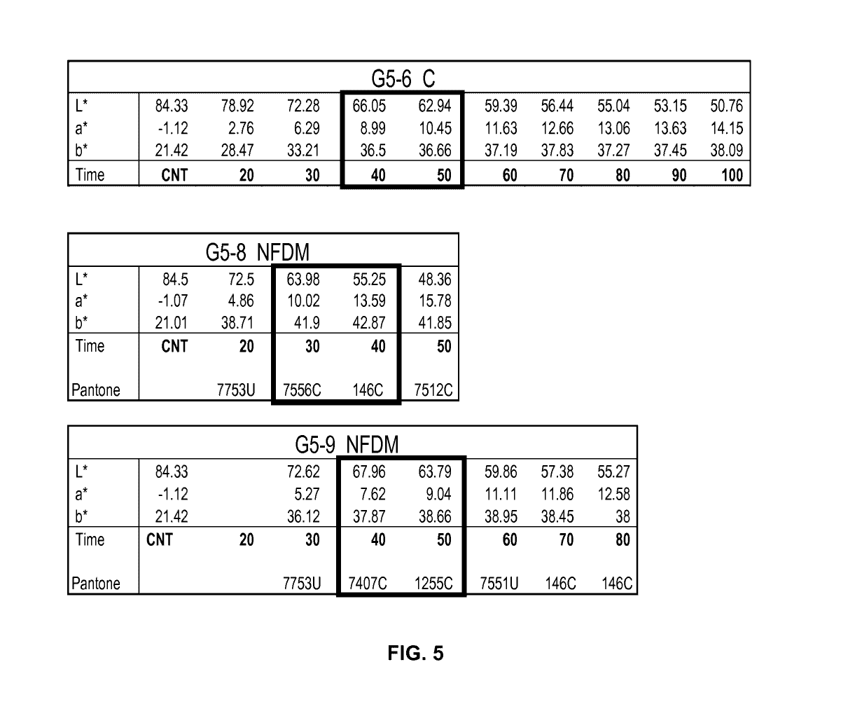

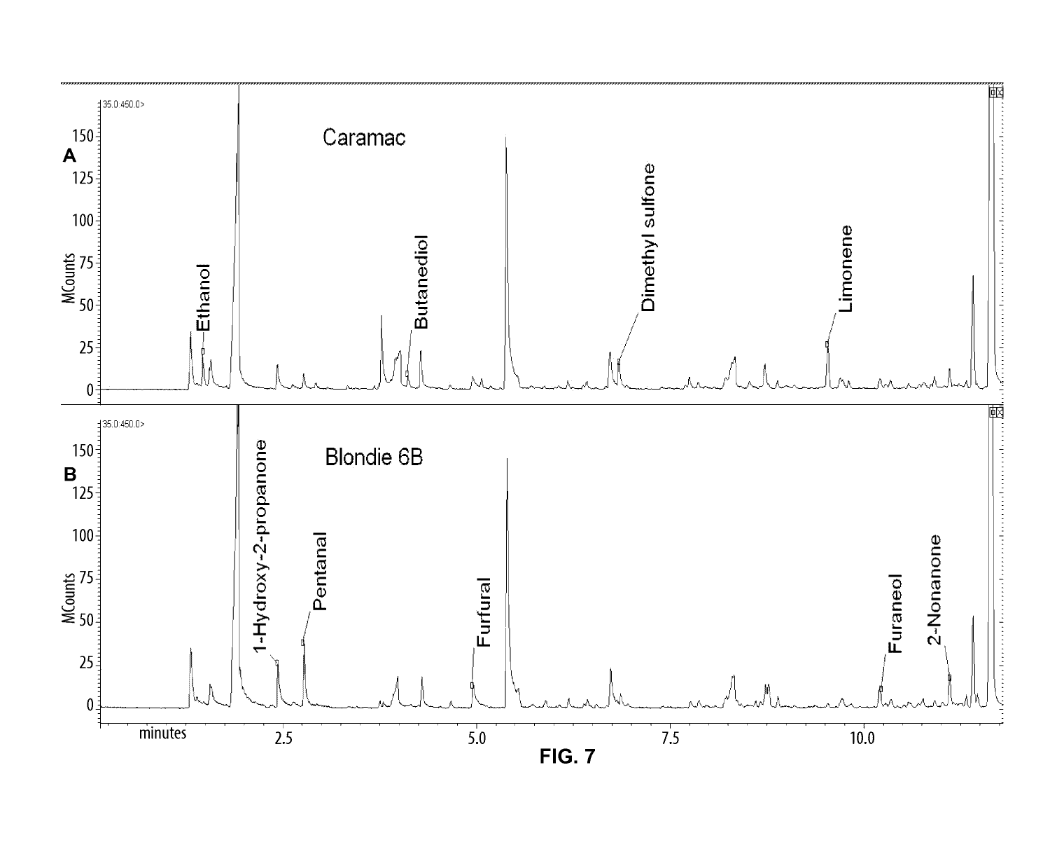

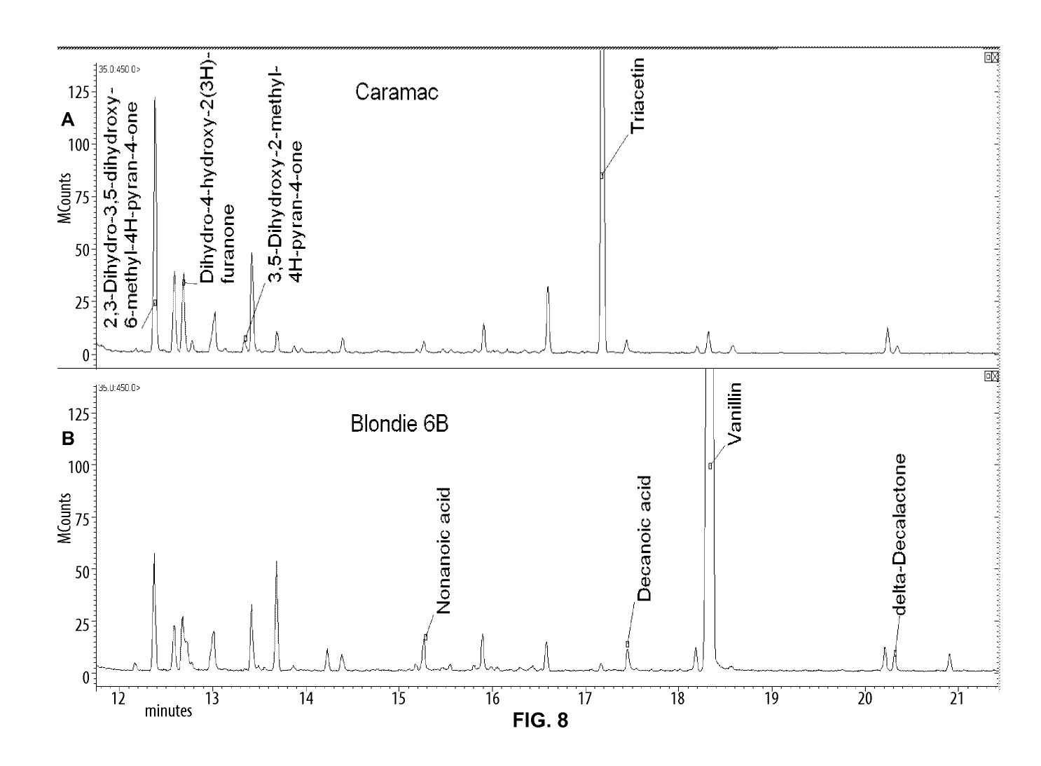

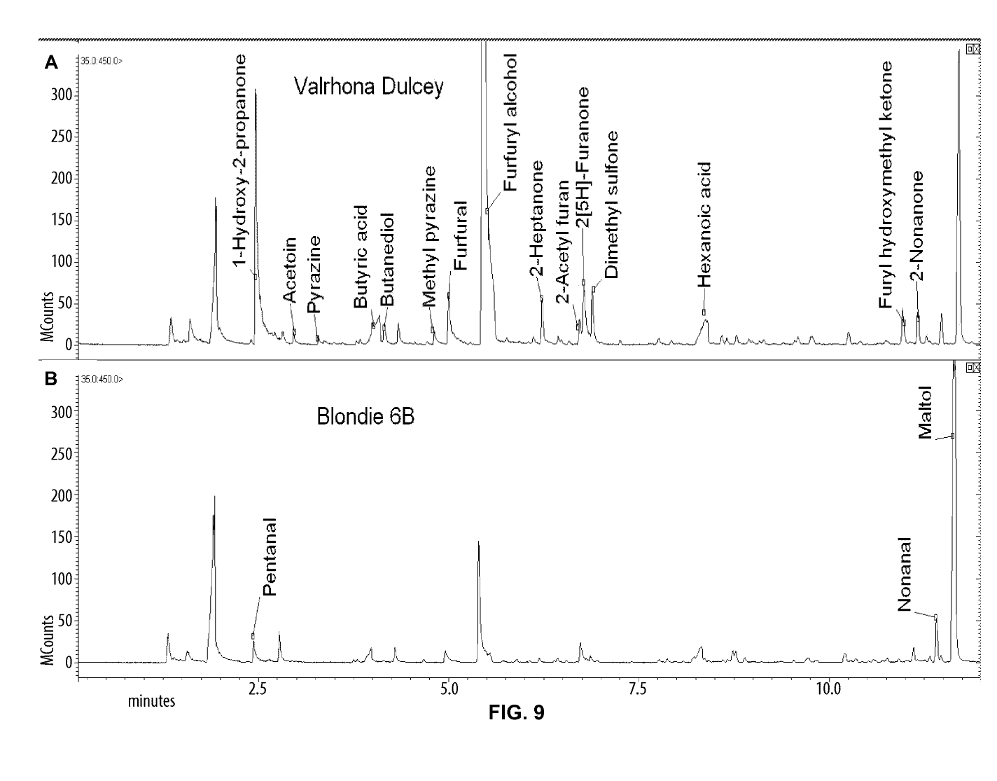

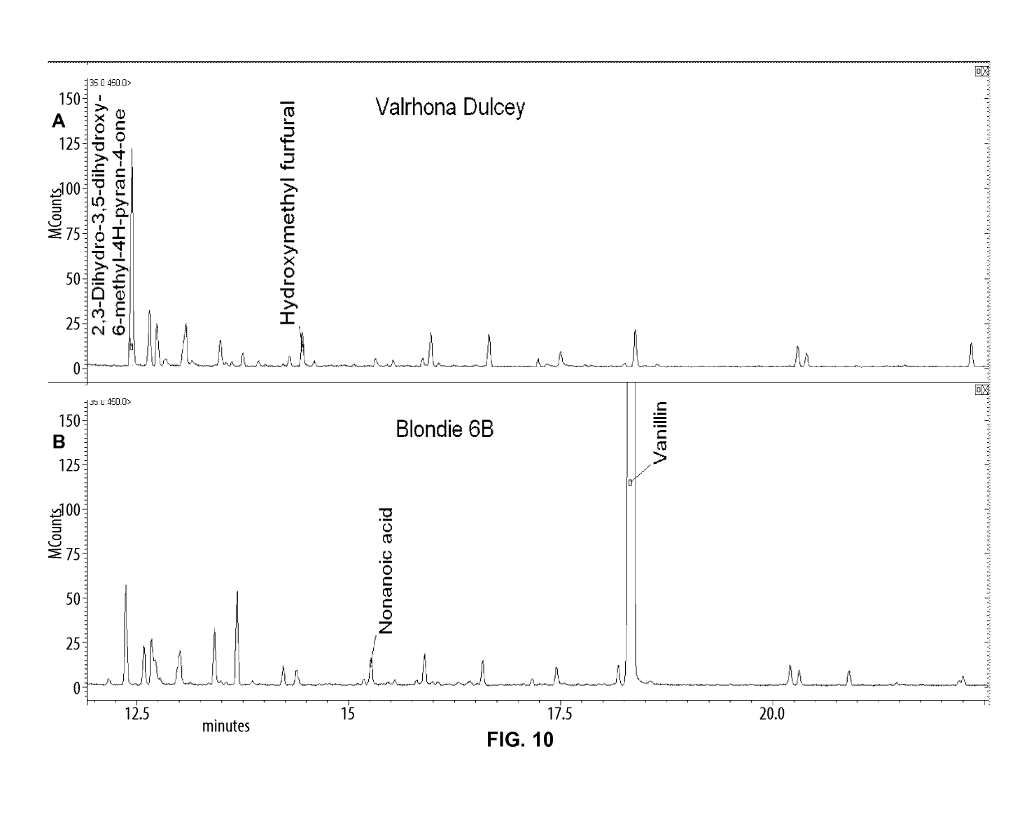

The Hershey 5 is blended with Hershey 1 (standard white chocolate recipe) at a one-to-one ratio and resulted in a product similar in flavor and color to Hershey 3. In addition to the color attributes, the products of this invention can be differentiated from current or prior products by its analytical flavor markers, its specific chemical fingerprint of component compounds (or absence thereof) as described herein, and/or the absence of detectable 2-hydro-3-methyl-2-cyclopenten-1-one (MCP) after cooling, such as after 24 hours of cooling, for example. Alternatively or in addition, the products of the invention can lack other detectable flavor markers in addition to or instead of lacking MCP, such as methyl-3-furoate, and/or methyl-2-furoate, depending on the process steps used. Thus, the confections and products of the invention can be explained in terms of the specific set of flavor compounds or chemical components either present or absent, such as any of the compounds and/or components listed in FIGS. 7-10, or any other identifiable peak or peaks in FIGS. 7-10 that establish a quantitative or qualitative difference between the inventive “Blondie” sample and the prior art white chocolate products shown. In FIG. 5, the three separate charts relate to three similar formulas and all can be heated to 250° F. The times listed (“Time” in charts) are from “steam on” to “steam off” as used in a 20-quart steam-jacketed Groen kettle or similar heating device. Starting chocolate temperatures are approximately 110° F. and the time to reach 250° F. is approximately 15 minutes.

G5-6 C sample uses the white chocolate base formula as shown in the Table under “G5-6 C” below. References to “Blondie 6” samples throughout this disclosure refer to different batches of the same “Blondie 6” noted below. The percentages listed are weight percent.

| | | | G5-8 | G5-9 |
|---|---|---|---|---|
| Ingredient | Blondie 6 | G5-6 C | NFDM | NFDM |
| Sucrose | 36.00% | 50.67% | 50.00% | 35.00% |
| Whole Milk | 11.00% | 22.00% | | |
| Powder | | | | |
| Nonfat Milk | 16.51% | | 16.50% | 26.50% |
| Powder | | | | |
| Cocoa Butter | 27.00% | 27.13% | 26.73% | 26.73% |
| AMF | 4.00% | | 6.37% | 6.37% |
| Lactose | 5.00% | | | 5.00% |
| Lecithin | 0.30% | 0.10% | 0.30% | 0.30% |
| PGPR | 0.15% | | | |
| Salt | 0.02% | 0.10% | 0.10% | 0.10% |
| Vanillin | 0.02% | | | |

The sample listed as Blondie 12 herein also contains brown sugar.

In certain examples, a standard referenced starting white chocolate material is used, as shown below:

White Chocolate Process

The white chocolate used in the invention is common to anyone knowledgeable in the art. Any process used to make white chocolate or white chocolate coatings could be used. For purpose of this invention, the following ingredients can be mixed together in a Globe SP20 mixer:

Sucrose—3040.2 grams

Whole milk powder (WMP)—1320.0 grams

Anhydrous milk fat (AMF)—60.0 grams

Salt—6.0 grams

Cocoa Butter (CB)—968.0 grams

This composition is mixed approximately 10 minutes to increase its temperature to 110 F using heat lamps. The heated mass is then refined to 22 microns using a Buhler 300 mm 3-roll refiner. After refining, 388.4 grams of cocoa butter is added. This mixture is conched in the same Globe mixer mentioned above for 90 minutes. Temperature of the mass is 125 F-130 F using the heat lamp. After 90 minutes, 211.4 grams of cocoa butter and 6.0 grams of lecithin can be added and mixed for 20 minutes. The final composition of the white chocolate base is as follows:

50.67% sucrose

26.13% CB

22.0% WMP

1.0% AMF

0.1% salt

0.1% lecithin

The white chocolate had the following physical properties:

0.62% moisture content

0.24 water activity

15,000 centipoise viscosity at 6.8 s−1 shear rate

Exemplary Caramelization of White Chocolate Process:

A white chocolate sample (6000 grams, mass temperature 110 F) is put into an OM-TDB TA/2 20-quart steam-jacketed Groen kettle. The agitator assembly of the Groen kettle can be modified to provide proper mixing. Example modifications are: 1) the secondary agitator is elongated to come within 1/4″ of the primary agitator, 2) a stationary paddle is installed that is configured to the contour of the primary mixer, and 3) clamps are installed to tightly compact the scraper blades on the primary agitator so they would not lift off the wall of the kettle.

The caramel-chocolate process can incorporate a heating-holding under constant agitation-cooling procedure. The heating cycle begins when 25 psi steam is applied to the kettle. The white chocolate mass temperature reaches 240° F. in about 10 minutes and 250° F. in about 20 minutes. The mass is held at 250° F. for an additional 40 minutes or as indicated. At the end of the heating cycle, 50° F. cooling water is applied and the mass temperature decreases to 130° F. in about 5 minutes.

Finished Product or Ingredient Characteristics:

The result of the above mentioned process in this invention produces a product that was significantly different in color and flavor than the starting white chocolate material.

Color: There is a considerable change in the products' color using the above process. The color of the white chocolate and caramel chocolate is determined using the L, a, b color space. “L” indicates lightness. An “L” value of 100 is white, and a value of 0 is black. The “a” value is green (−a) to red (+a) and the “b” value is from blue (−b) to yellow (+b). White chocolate had the following values:

L=84

a=−1

b=21

After processing, the values of the caramel chocolate of the invention are:

L=62

a=10

b=38

These values correspond to the standard Pantone 7556U. As noted, the details of the color variations can be appreciated in the charts of FIG. 5.

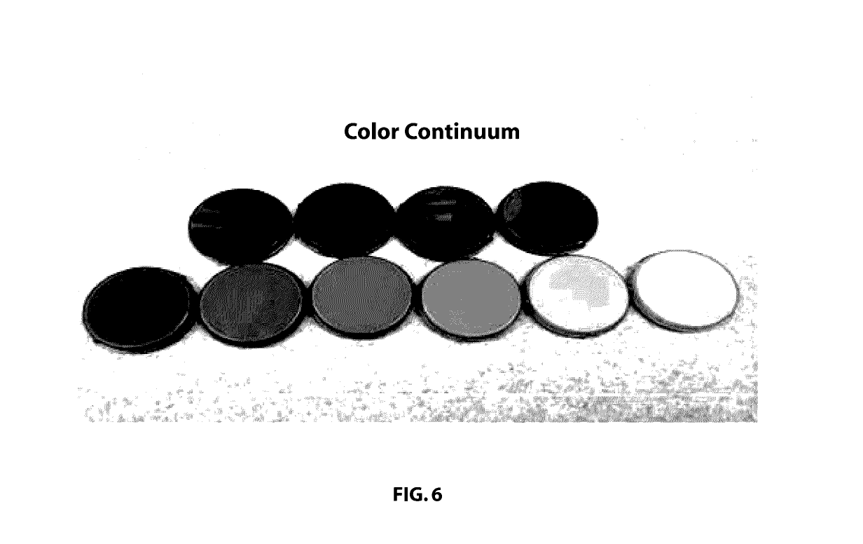

Based on consumer preference or the ingredient or final product desired, a range of colors can be delivered through this invention. A color photograph illustrating the possible range of colors can be found in FIG. 6.

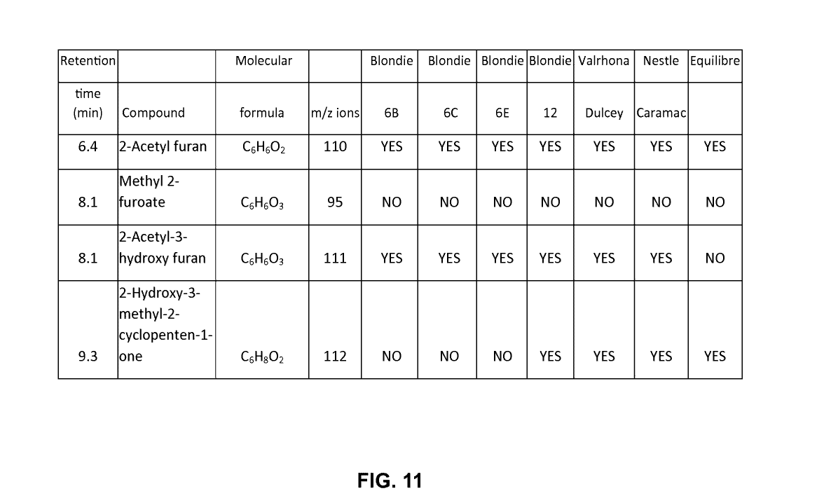

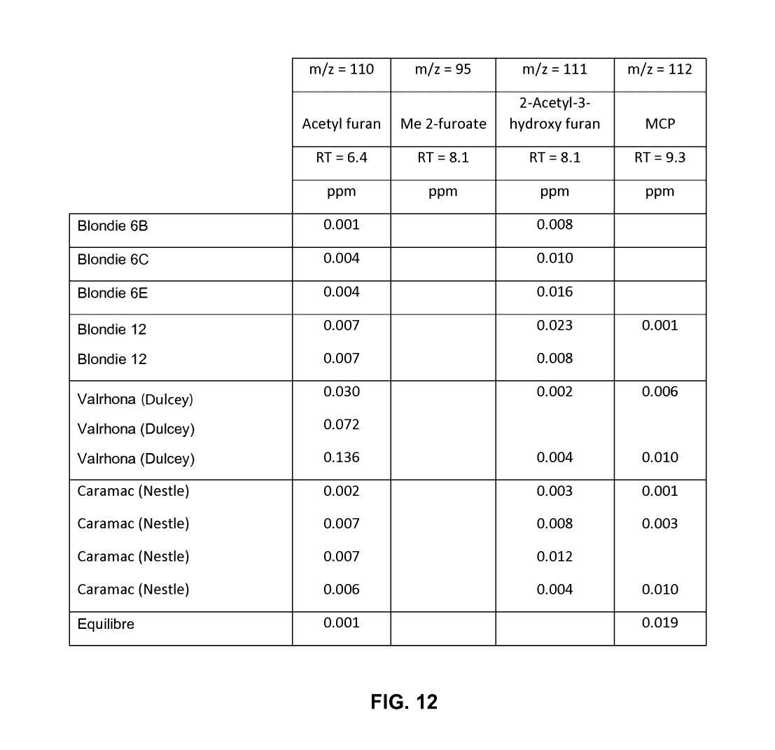

Flavor: The flavor makers that can be detected are 2-Acetyl furan and 2-Acetyl-3-hydroxy furan. However, not detected in preferred samples of the invention is the flavor component 2-Hydroxy-3-methyl-2-cyclopenten-1-one (MCP), and in other embodiments the flavor components MCP and methyl 2-furoate are both not detected after producing the final product or ingredient. The flavor components methyl 3-furoate and methyl 2-furoate can be separated by chromatographic techniques available in the art. These flavor components are noted in U.S. Pat. No. 8,137,726, however that document refers to a compound as “methyl furanoate,” which is presumably methyl 2-furoate. The presence of compounds as listed in U.S. Pat. No. 8,137,726 is not correct as shown in the data here in FIGS. 11 and 12. These FIGS. 11-12 also demonstrate the novel characteristics of the samples of the invention, labeled as the various “Blondie” samples and batches.

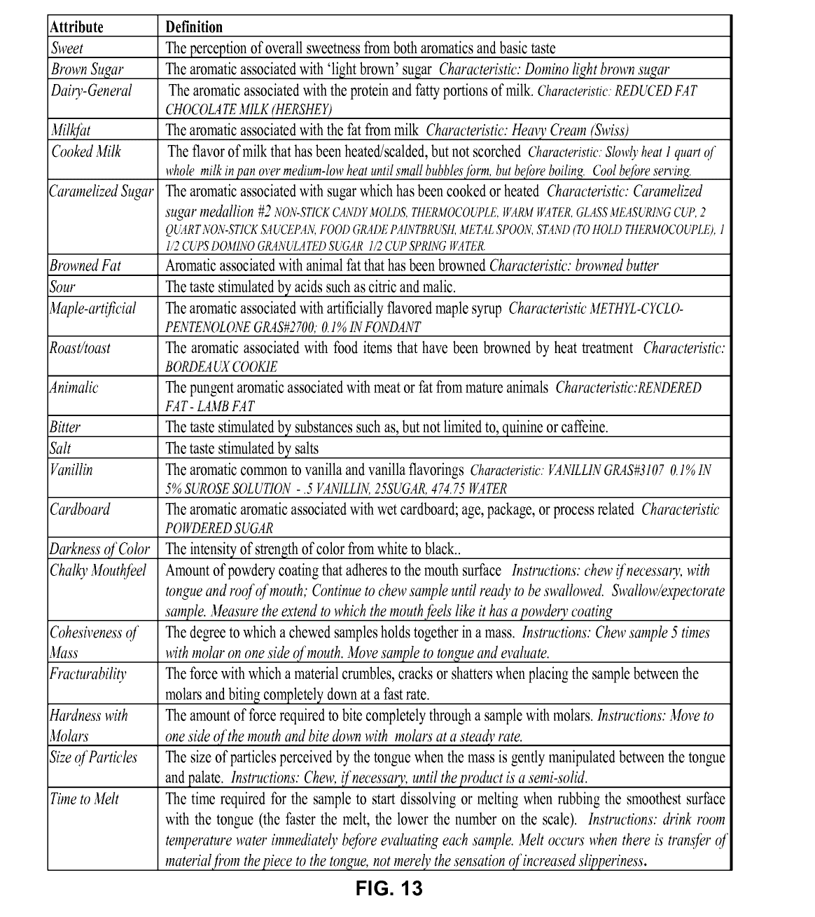

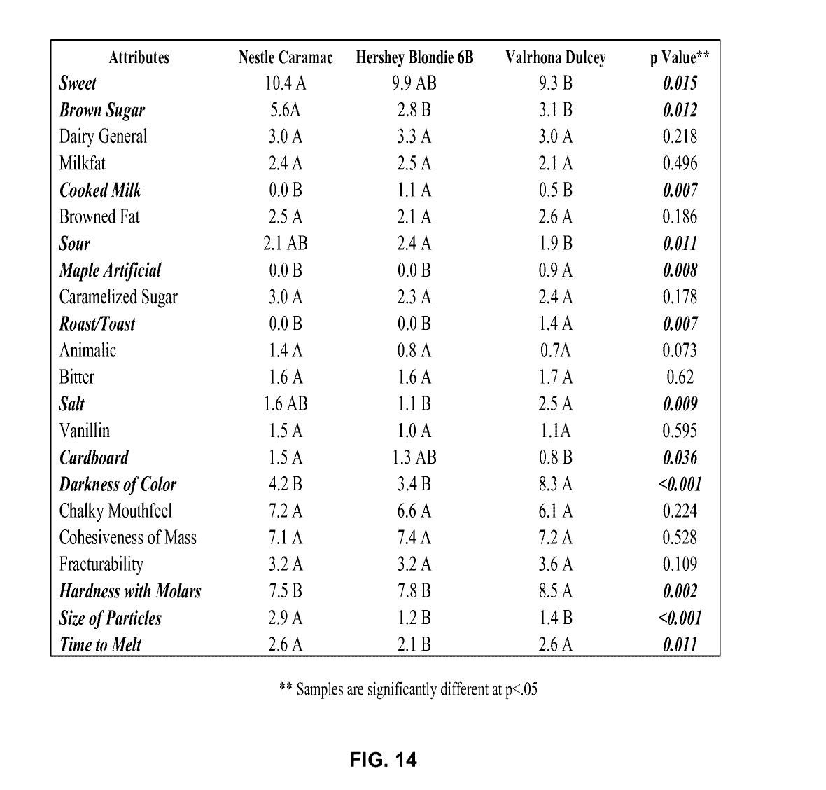

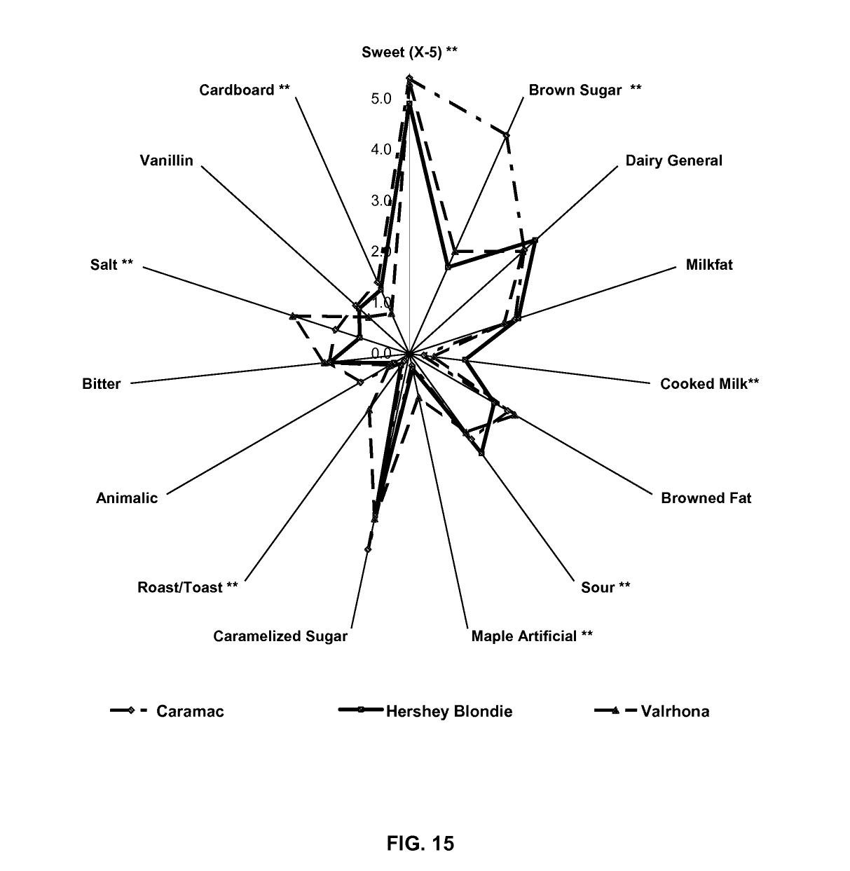

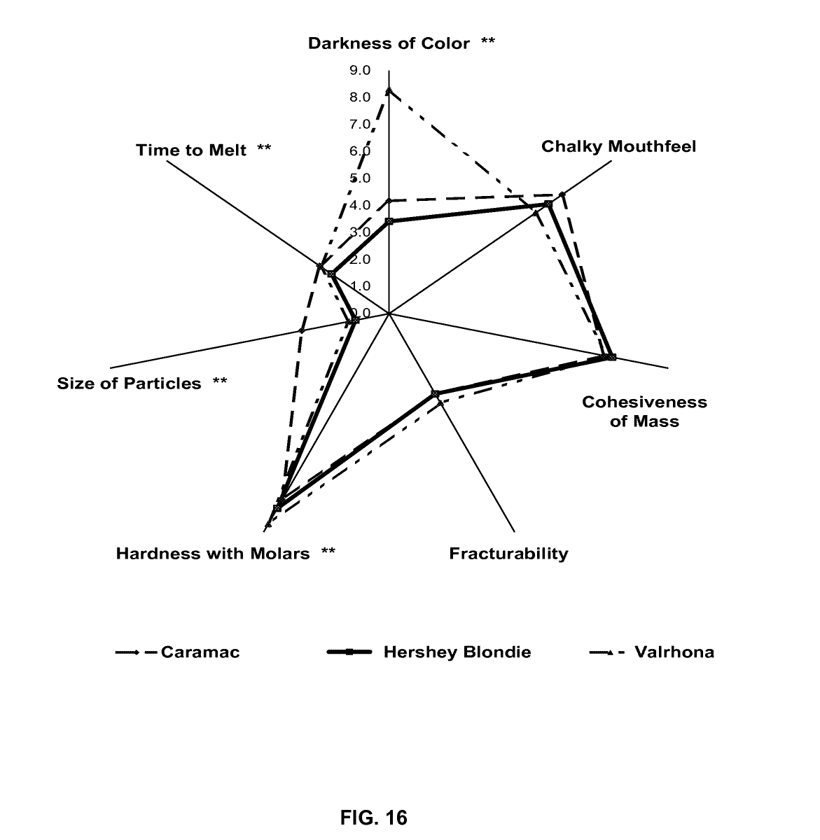

As flavor is a key differentiator between the product made from this invention and commercially available products, the sensory profiling shown here is one way to quantify the differences and advantages of the invention. In FIGS. 13-16 the sensory data confirm that the process described here yields flavor descriptors and/or intensities different from Caramac and Valrhona Dulcey.

Another way to quantify flavor differences is through a GC/MS analytical method. In the FIGS. 7-10, graphs of a chocolate made with the present invention along with the two commercial chocolates: Caramac and Valrhona Dulcey. The results show differences in key flavor peaks. One of skill in the art can devise several differences from these data in order to differentiate the content of the samples from the invention from commercial samples and any of the peaks shown as different in FIGS. 7-10 can be used to characterize a product of the invention. In addition, the levels of various compounds can be ascertained by the volume under the peaks. Thus, differences in the amount of certain components as listed in the graphs of evidenced by the peaks present can form the basis for one or more differentiating characteristics of the products herein.

Examplary Chromatogram Comparisons:

Caramac contains a flavor solvent, triacetin, indicating the presence of an added (artificial or natural) flavoring.

Compared to Caramac, Blondie 6B of the invention contains higher levels of the following compounds: furfural (sweet, brown, woody, bready, caramellic odor descriptors), furaneol (sweet, cotton candy, caramel, strawberry, sugar odor descriptors) and delta-decalactone (sweet, creamy, fatty, coconut, milk odor descriptors).

Valrhona Dulcey contains a large peak of 2-furanmethanol which has been described as having a faint, burning odor and a bitter taste with odor descriptors of sulfuraceous estery chemical, musty, sweet, brown, caramellic, bready and coffee.

Compared to Valrhona Dulcey, Blondie 6B of the invention contains higher levels of maltol (sweet, caramellic, cotton candy, jammy fruity odor descriptors).

Analytical Method Summary:

For extraction of the volatile compounds, all samples are frozen and then ground to a fine powder. Two grams are placed in 20 mL headspace vials along with 0.2 g of isobutyl thiazole internal standard at three levels (4.9 ppm, 27.9 ppm and 75.0 ppm) and the vials were capped. Each vial was place in a 85° C. heat block for a 5 minute preheat prior to extraction by solid phase microextraction (SPME). A 50/30 um DVB/Carboxen/PDMS stable flex SPME fiber was placed in the vial and the fiber was exposed for 20 minutes at 85° C.

Identification of the flavor compounds was accomplished using a Varian 450 gas chromatograph (GC) coupled to a Varian 320 triple quadrupole mass spectrometer (MS). Analysis of the volatiles adsorbed on to the SPME fiber was accomplished using the following parameters: Desorption time of 3 minutes into the split/splitless injector heated at 250° C., split ratio 20:1 and helium carrier gas at 1.2 ml/minute constant flow; Analytical capillary column: Restek Rtx-5, 30 m×0.25 mm×0.25 μm; Oven program: 35° C. to 250° C. at 6° C./minute; 0.17 minute hold then 20° C./minute to 300° C., final hold time of 20 minutes; Detector: Varian 320 GC/MS, 70 eV, 35-450 amu scan in Electron impact ionization (EI) mode.

The Tables of FIGS. 11 and 12 show exemplary results in the presence of and levels of specific flavor components detected in samples described herein or in commercial samples.

White Chocolate with 25% Ribose (Reaction at 50.2° C. No Agitation)

Some of the following examples employ ribose reducing sugar. The use of ribose allows the temperature to be reduced to about 40-50° C. with longer heating times while still generating the flavor and color profiles as used in the examples with temperatures about 200° F. or above. For these or any of the examples here, any process used to make white chocolate or white chocolate coatings could be used. For purposes of this invention, the following ingredients are mixed together in a Globe 8 qt mixer

| INGREDIENT | g |
|---|---|
| SUCROSE | 500.00 |
| RIBOSE | 500.00 |
| NON FAT DRY MILK | 340.00 |
| COCOA BUTTER | 481.15 |

This composition is mixed approximately 10 minutes to increase its temperature to 43° C. using a water bath. The heated mass is then refined to 20 microns using a Buhler 300 mm 3-roll refiner. After refining, 49.31 g of cocoa butter is added. This mixture is conched in an 8 qt Globe mixer for 120 minutes. Temperature of the mass is 45° C. controlled by a water bath. After 120 minutes, 15.54 g of cocoa butter, 100 g of anhydrous milk fat (AMF), and 14.00 g of lecithin are added and mixed for 30 minutes. The final composition of the white chocolate base is as follows:

| INGREDIENT | g | % |
|---|---|---|
| SUCROSE | 500.00 | 25.00% |
| RIBOSE | 500.00 | 25.00% |
| NON FAT DRY MILK | 340.00 | 17.00% |
| COCOA BUTTER | 546.000 | 27.65% |
| ANHYDROUS MILK | 100.000 | 5.00% |
| FAT | | |
| SOY LECITHIN | 14.000 | 0.70% |

The product is stored without mixing in a hot cabinet at 50.2° C. until the desired degree of caramelization occurs.

### Flavor Data

| | | | Furfuryl | 2-(5H)- |
|---|---|---|---|---|
| @50.2° C. | Acetic acid | Furfural | alcohol | Furanone |
| Days | ppm | Ppm | ppm | ppm |
| 16 | 3.119 | 59 | 850 | 1.98 |
| | 2-Hydroxy- | | | |
| | 3-methyl- | | Furyl | |
| Me 2- | 2-cyclopenten- | | hydroxymethyl | |
| furoate | 1-one | Furaneol | ketone | Maltol |
| ppm | ppm | Ppm | ppm | ppm |
| <0.00 | <0.001 | 0.02 | 0.007 | 524 |

### Color Data Over Time

| @50.2 C. | 25% Ribose | | |
|---|---|---|---|
| Days | L* | a* | b* |
| 2 | 74.62 | 1.59 | 33.58 |
| 5 | 63.45 | 9.85 | 42.72 |
| 6 | 61.02 | 10.59 | 39.45 |
| 9 | 53.81 | 14.6 | 33.64 |
| 12 | 50.18 | 15.64 | 30.69 |
| 14 | 49.02 | 15.48 | 27.77 |
| 16 | 45.83 | 15.82 | 27.51 |

White Chocolate with 10% Ribose (Reaction at 50.2° C. with No Agitation)

Any process used to make white chocolate or white chocolate coatings could be used. For purposes of this invention, the following ingredients are mixed together in a Globe 8 qt mixer:

| INGREDIENT | g |
|---|---|
| SUCROSE | 800.00 |
| RIBOSE | 200.00 |
| NON FAT DRY MILK | 340.00 |
| COCOA BUTTER | 481.15 |

This composition is mixed approximately 10 minutes to increase its temperature to 43° C. using a water bath. The heated mass is then refined to 20 microns using a Buhler 300 mm 3-roll refiner. After refining, 49.31 g of cocoa butter is added. This mixture is conched in an 8 qt Globe mixer for 120 minutes. Temperature of the mass is 45° C. controlled by a water bath. After 120 minutes, 15.54 g of cocoa butter, 100 g of anhydrous milk fat (AMF), and 14.00 g of lecithin are added and mixed for 30 minutes. The final composition of the white chocolate base is as follows:

| INGREDIENT | g | % |
|---|---|---|
| SUCROSE | 800.00 | 40.00% |
| RIBOSE | 200.00 | 10.00% |
| NON FAT DRY MILK | 340.00 | 17.00% |
| COCOA BUTTER | 546.00 | 27.65% |
| ANHYDROUS MILK FAT | 100.00 | 5.00% |
| SOY LECITHIN | 14.00 | 0.70% |

The product is stored without mixing in a hot cabinet at 50.2° C. until the desired degree of caramelization occurs.

### Flavor Data

| | | | Furfuryl | 2-(5H)- |
|---|---|---|---|---|
| @50.2 C. | Acetic acid | Furfural | alcohol | Furanone |
| Days | ppm | ppm | ppm | ppm |
| 16 | 4.738 | 44 | 227 | 1.72 |
| | 2-Hydroxy- | | | |
| | 3-methyl-2- | | Furyl | |
| Me 2- | cyclopenten- | | hydroxymethyl | |
| furoate | 1-one | Furaneol | ketone | Maltol |
| ppm | ppm | ppm | ppm | ppm |
| <0.001 | <0.001 | 0.02 | <0.001 | 8 |

### Color Data Over Time

| @ 50.2 C. | 10% Ribose | | |
|---|---|---|---|
| Days | L* | a* | b* |
| 2 | 77.54 | −0.30 | 27.64 |
| 5 | 72.22 | 3.69 | 36.38 |
| 6 | 71.15 | 4.79 | 37.33 |
| 7 | 69.70 | 5.95 | 37.31 |
| 8 | 67.64 | 7.15 | 39.88 |
| 9 | 66.15 | 8.34 | 40.80 |
| 12 | 61.28 | 11.74 | 38.09 |
| 14 | 59.04 | 12.83 | 36.98 |
| 16 | 55.63 | 14.88 | 36.35 |

White Chocolate with 5% Ribose (Reaction at 50.2° C. with No Agitation)

Any process used to make white chocolate or white chocolate coatings could be used. For purposes of this invention, the following ingredients are mixed together in a Globe 8 qt mixer

| INGREDIENT | g |
|---|---|
| SUCROSE | 900.00 |
| RIBOSE | 100.00 |
| NON FAT DRY MILK | 340.00 |
| COCOA BUTTER | 481.15 |

This composition is mixed approximately 10 minutes to increase its temperature to 43° C. using a water bath. The heated mass is then refined to 20 microns using a Buhler 300 mm 3-roll refiner. After refining, 49.31 g of cocoa butter is added. This mixture is conched in an 8 qt Globe mixer for 120 minutes. Temperature of the mass is 45° C. controlled by a water bath. After 120 minutes, 15.54 g of cocoa butter, 100 g of anhydrous milk fat (AMF), and 14.00 g of lecithin are added and mixed for 30 minutes. The final composition of the white chocolate base is as follows:

| INGREDIENT | G | % |
|---|---|---|
| SUCROSE | 900.00 | 45.00% |
| RIBOSE | 100.00 | 5.00% |
| NON FAT DRY MILK | 340.00 | 17.00% |
| COCOA BUTTER | 546.00 | 27.65% |
| ANHYDROUS MILK FAT | 100.00 | 5.00% |
| SOY LECITHIN | 14.00 | 0.70% |

The product is stored without mixing in a hot cabinet at 50.2° C. until the desired degree of the product's caramelization occurs.

### Flavor Data

| | | | Furfuryl | 2-(5H)- |
|---|---|---|---|---|
| @50.2 C. | Acetic acid | Furfural | alcohol | Furanone |
| Days | ppm | ppm | ppm | ppm |
| 16 | 4.683 | 14 | 95 | 0.8 |
| | 2-Hydroxy- | | | |
| | 3-methyl-2- | | Furyl | |
| Me 2- | cyclopenten- | | hydroxymethyl | |
| furoate | 1-one | Furaneol | ketone | Maltol |
| ppm | ppm | ppm | ppm | ppm |
| <0.001 | <0.001 | 0.05 | <0.001 | 6 |

### Color Data Over Time

| @ 50.2 C. | 5% Ribose | | |
|---|---|---|---|
| Days | L* | a* | b* |
| 2 | 79.15 | −0.62 | 24.50 |
| 5 | 75.10 | 1.72 | 31.97 |
| 6 | 74.09 | 2.57 | 33.68 |
| 7 | 73.34 | 3.30 | 33.03 |
| 8 | 72.11 | 4.02 | 35.21 |
| 9 | 72.04 | 4.68 | 35.79 |
| 12 | 69.28 | 6.32 | 36.06 |
| 13 | 68.73 | 6.95 | 36.63 |
| 14 | 67.99 | 7.17 | 36.02 |
| 15 | 68.04 | 7.28 | 36.56 |
| 16 | 67.06 | 8.34 | 36.83 |

White Chocolate with 1% Ribose (Reaction at 50.2° C. with No Agitation)

Any process used to make white chocolate or white chocolate coatings could be used. For purposes of this invention, the following ingredients are mixed together in a Globe 8 qt mixer:

| INGREDIENT | g |
|---|---|
| SUCROSE | 980.00 |
| RIBOSE | 20.00 |
| NON FAT DRY MILK | 340.00 |
| COCOA BUTTER | 481.15 |

This composition is mixed approximately 10 minutes to increase its temperature to 43° C. using a water bath. The heated mass is then refined to 20 microns using a Buhler 300 mm 3-roll refiner. After refining, 49.31 g of cocoa butter is added. This mixture is conched in an 8 qt Globe mixer for 120 minutes. Temperature of the mass is 45° C. controlled by a water bath. After 120 minutes, 15.54 g of cocoa butter, 100 g of anhydrous milk fat (AMF), and 14.00 g of lecithin are added and mixed for 30 minutes. The final composition of the white chocolate base or starting material is as follows along with the flavor markers data and color data:

| INGREDIENT | g | % |
|---|---|---|
| SUCROSE | 980.00 | 49.000% |
| RIBOSE | 20.00 | 1.000% |
| NON FAT DRY MILK | 340.00 | 17.000% |
| COCOA BUTTER | 546.00 | 27.650% |
| ANHYDROUS MILK FAT | 100.00 | 5.000% |
| SOY LECITHIN | 14.000 | 0.700% |

### Flavor Data Over Time

| | | | Furfural | |
|---|---|---|---|---|
| @50.2 C. | | Furfural | alcohol | 2-(5H)- |
| Days | | ppm | ppm | Furanone |
| 16 | | 1.82 | 83 | 0.15 |
| | 2-Hydroxy- | | | |
| | 3-methyl-2- | | Furyl | |
| Me 2- | cyclopenten- | | hydroxymethyl | |
| furoate | 1-one | Furaneol | ketone | Maltol |
| ppm | ppm | ppm | ppm | ppm |
| <0.001 | <0.001 | 0.02 | <0.001 | 2 |

### Color Data Over Time

| @ 50.2 C. | 1% | | |
|---|---|---|---|
| Days | L* | a* | b* |
| 2 | 80.73 | −1.04 | 21.84 |
| 5 | 78.12 | −0.24 | 24.85 |
| 6 | 77.78 | 0.02 | 25.74 |
| 7 | 77.83 | 0.29 | 25.92 |
| 8 | 77.26 | 0.53 | 27.34 |
| 9 | 77.10 | 0.75 | 27.58 |
| 12 | 76.29 | 1.38 | 28.39 |
| 13 | 75.64 | 1.58 | 29.54 |
| 14 | 75.36 | 0.63 | 28.16 |
| 15 | 76.02 | 1.84 | 28.21 |
| 16 | 75.45 | 1.95 | 28.64 |

### Example (CC-012)—Cooking Fats and Non Fat Dry Milk Component Only

The following ingredients are mixed in a Globe 8 qt mixer for 10 minutes to heat the paste to 31° C.

| INGREDIENT | g |
|---|---|
| NON FAT DRY MILK | 346.10 |
| COCOA BUTER | 290.00 |
| SOY LECIHIN | 3.87 |
| ANHYDROUS MILK FAT | 101.43 |
| TOTAL - | 741.40 |

The previous mix is transferred to a Bottom Line Technologies Caramel Cooker (0306055), with an adapted scraped-surface agitator. Heating begins when the pot is placed over the pre-heated cooker. The white chocolate mass temperature reaches a maximum temperature of 125° C. in 14 min. At the end of the heating cycle, the pot is placed in a 13° C. cooling water bath and the mass is cooled down to under 50° C. A decrease of one L* value unit is considered the start of flavor and color development.

This composition is mixed with 992.80 g of sucrose approximately 10 minutes (temperature of 43° C. using a water bath). The heated mass is then refined to 20 microns using a Buhler 300 mm 3-roll refiner. After refining, 96.26 g of cocoa butter is added. This mixture is conched in an 8 qt Globe mixer for 120 minutes. Temperature of the mass is 70° C. controlled by a water bath. After 120 minutes, 169.55 g of cocoa butter and 2.00 g of lecithin are added and mixed for 30 minutes. The final composition of the caramelized chocolate is as follows:

| INGREDIENT | g | |
|---|---|---|
| SUCROSE | 992.80 | 49.59% |
| NFDM | 346.10 | 17.29% |
| COCOA BUTTER | 555.81 | 27.76% |
| AMF | 101.43 | 5.07% |
| SOY LECITHIN | 5.871 | 0.29% |

### Color Data of Cooked Paste

| | COLOR | | |
|---|---|---|---|
| SAMPLE | L | a | b |
| INITIAL | 71.72 | −0.70 | 26.61 |
| 15 min | 42.41 | 14.56 | 21.16 |

### Final Caramelized Chocolate Color after Refining, Conching, Standardizing

| | COLOR | | |
|---|---|---|---|
| SAMPLE | L | a | b |
| 15 min | 62.15 | 11.54 | 37.94 |

### Flavor Data of Caramelized Chocolate

| | | | Furfuryl | 2-(5H)- |
|---|---|---|---|---|
| | Acetic acid | Furfural | alcohol | Furanone |
| SAMPLE | ppm | ppm | ppm | ppm |
| 15 min | 1.922 | 0.16 | 162 | 0.32 |
| | 2-Hydroxy- | | | |
| | 3-methyl-2- | | Furyl | |
| Me 2- | cyclopenten- | | hydroxymethyl | |
| furoate | 1-one | Furaneol | ketone | Maltol |
| ppm | ppm | ppm | ppm | ppm |
| <0.001 | <0.001 | 0.21 | 0.099 | 83 |

### Example (G5-115)—Fat and Whole Milk Component Cooked

The following ingredients are mixed in a 20 qt Globe mixer for around 10 minutes.

| INGREDIENT | g |
|---|---|
| WHOLE MILK POWDER | 4378.13 |
| COCOA BUTTER | 2926.75 |
| SOY LECHITHIN | 48.97 |
| ANHYDROUS MILK FAT | 1283.07 |
| TOTAL - | 8636.92 |

The paste is transferred to a 20 qt steam-jacketed Groen kettle. The agitator of the kettle was modified for proper mixing. The heating cycle begins when 25 psi steam is applied to the kettle. The mass is cooked for 40 minutes up to a temperature of 118.8° C. Samples of this cooked paste were taken after 20, 25, 30, and 40 min of cooking. Each sample was cooled down using a 10° C. water bath while agitating.

For each of the cook levels 450.00 g of paste were mixed 660.00 g of sucrose approximately 10 minutes (temperature of 43° C. using a water bath). The heated mass is then refined to 20 microns using a Buhler 300 mm 3-roll refiner. After refining each batch, 40.00 g of cocoa butter is added. This mixture is conched in an 8 qt Globe mixer for 120 minutes. Temperature of the mass is 70° C. controlled by a water bath. After 120 minutes, 82.25 g of cocoa butter is added and mixed for 30 minutes. The final composition of each of the caramelized chocolates is as follows:

| | |
|---|---|
| SUCROSE | 49.640% |
| WMP | 17.305% |
| COCOA BUTTER | 23.000% |
| AMF | 5.071% |
| LECITHIN | 0.194% |

### Color Data of the Cooked Paste at Different Cooking Times

| | COLOR | | |
|---|---|---|---|
| SAMPLE | L | a | b |
| INITIAL | 81.57 | −1.26 | 20.29 |
| 20 min | 77.75 | 0.18 | 27.09 |
| 25 min | 72.33 | 3.94 | 32.24 |
| 30 min | 65.69 | 7.30 | 32.42 |
| 40 min | 51.98 | 13.10 | 31.29 |

### Final Caramelized Chocolate Color Data

| | COLOR | | |
|---|---|---|---|
| SAMPLE | L | a | b |
| 20 min | 82.94 | −0.27 | 23.68 |
| 25 min | 79.90 | 1.63 | 27.90 |
| 30 min | 76.11 | 4.16 | 31.54 |
| 40 min | 66.36 | 9.24 | 35.69 |

### Final Caramelized Chocolate Flavor Data

| | | Furfuryl | 2-(5H)- |
|---|---|---|---|
| | Furfural | alcohol | Furanone |
| SAMPLE | ppm | ppm | ppm |
| 20 min | <0.01 | 29 | 0.10 |
| 25 min | 0.04 | 51 | 0.27 |
| 30 min | 0.11 | 70 | 0.41 |
| 40 min | 0.40 | 109 | 0.85 |

| | | 2-Hydroxy- | | | |
|---|---|---|---|---|---|
| | | 3-methyl-2- | | Furyl | |
| | Me 2- | cyclopenten- | | hydroxymethyl | |
| | furoate | 1-one | Furaneol | ketone | Maltol |
| SAMPLE | ppm | ppm | ppm | ppm | ppm |
| 20 min | <0.001 | <0.001 | 0.03 | <0.001 | 5 |
| 25 min | <0.001 | <0.001 | 0.13 | <0.001 | 19 |
| 30 min | <0.001 | <0.001 | 0.16 | 0.078 | 36 |
| 40 min | <0.001 | 0.003 | 0.31 | 0.474 | 103 |

### Example (CC-015)—Canola Lecithin Content (2%) with Palm Kernel and Palm Oil Fats and Cocoa Liquor

According to the invention, some of the following examples use an edible fat that is not cocoa butter as an option. In addition, they can also include cocoa liquor, or chocolate liquor, in order to produce a milk chocolate-type product as opposed to a white chocolate-type product. Thus, the invention specifically includes compositions made with cocoa butter replacers, cocoa butter equivalents, and other edible fats used in place of all or a part of the cocoa butter, as well as the methods for making food products and ingredients using these edible fats. Also, the methods and compositions of the invention specifically include using cocoa solids containing ingredients, such as, for example, chocolate liquor, cocoa powder, cocoa extracts, cocoa kibble, and pressed cocoa cake, and other products used in the production of cocoa products and chocolate. Any process used to make chocolate or coatings could be used. For purposes of this invention, the following ingredients are mixed together in a Globe 8 qt mixer

| INGREDIENT | g |
|---|---|
| SUCROSE | 1060.000 |
| WHOLE MILK POWDER | 400.000 |
| PALM KERNEL OIL | 345.00 |

This composition is mixed approximately 10 minutes to increase its temperature to 43° C. using a water bath. The heated mass is then refined to 20 microns using a Buhler 300 mm 3-roll refiner. After refining, 16.62 g of palm kernel oil is added. This mixture is conched in an 8 qt Globe mixer for 120 minutes. Temperature of the mass is 45° C. controlled by a water bath. After 120 minutes, 144.38 g of palm kernel oil, 70.00 g of a fat blend of palm kernel and palm oil, 32.00 g of chocolate liquor, 20.00 g of anhydrous milk fat (AMF), and 42.60 g of canola lecithin are added and mixed for 30 minutes. The final composition of the chocolate compound is as follows:

| INGREDIENT | g | |
|---|---|---|
| SUCROSE | 1060.00 | 49.75% |
| WHOLE MILK POWDER | 400.00 | 18.77% |
| CHOCOLATE LIQUOR | 32.00 | 1.50% |
| PALM KERNEL OIL | 506.00 | 23.75% |
| PALM OIL + PALM KERNEL OIL | 70.00 | 3.29% |
| ANHYDROUS MILK FAT | 20.00 | 0.94% |
| CANOLA LECITHIN | 42.60 | 2.00% |

Only 800 g of the previous mix is transferred to a Bottom Line Technologies Caramel Cooker (0306055), with an adapted scraped-surface agitator. Heating begins when the pot is placed over the pre-heated cooker. Within 28 minutes the mass reaches a maximum temperature of 135° C. At the end of the heating cycle, the pot is placed in a 13° C. cooling water bath and the mass is cooled down to under 50° C.

COLOR DATA

| | COLOR | | |
|---|---|---|---|
| SAMPLE | L | a | b |
| INITIAL | 64.16 | 5.66 | 15.70 |
| 28 min | 56.15 | 9.31 | 24.29 |

### Flavor Data

| | | | Furfuryl | 2-(5H)- |
|---|---|---|---|---|
| | | Furfural | alcohol | Furanone |
| SAMPLE | | ppm | ppm | ppm |
| 28 min | | 1.08 | 127.00 | 1.78 |
| | 2-Hydroxy- | | | |
| | 3-methyl-2- | | Furyl | |
| Me 2- | cyclopenten- | | hydroxymethyl | |
| furoate | 1-one | Furaneol | ketone | Maltol |
| ppm | ppm | ppm | ppm | ppm |
| <0.001 | <0.001 | 0.38 | 0.35 | 133.00 |

### Example (CC-014)—with Sun Flower Lecithin

Any process used to make chocolate or coatings could be used. For purpose of this invention, the following ingredients are mixed together in a Globe 8 qt mixer:

| INGREDIENT | g |
|---|---|
| SUCROSE | 1060.000 |
| WHOLE MILK POWDER | 400.000 |
| PALM KERNEL OIL | 314.00 |

This composition is mixed approximately 10 minutes to increase its temperature to 43° C. using a water bath. The heated mass is then refined to 20 microns using a Buhler 300 mm 3-roll refiner. After refining, 47.62 g of palm kernel oil is added. This mixture is conched in an 8 qt Globe mixer for 120 minutes. Temperature of the mass is 45° C. controlled by a water bath. After 120 minutes, 144.38 g of palm kernel oil, 70.00 g of a fat blend of palm kernel and palm oil, 20.00 g of anhydrous milk fat (AMF), and 14.00 g of sunflower lecithin are added and mixed for 30 minutes. The final composition of the coating is as follows:

| INGREDIENT | g | |
|---|---|---|
| SUCROSE | 1060.00 | 51.21% |
| WMP | 400.00 | 19.32% |
| PALM KERNEL OIL | 506.00 | 24.44% |
| PALM OIL + PALM KERNEL OIL | 70.00 | 3.38% |
| AMF | 20.00 | 0.97% |
| SUNFLOWER LECITHIN | 14.00 | 0.68% |

Only 800 g of the previous mix is transferred to a Bottom Line Technologies Caramel Cooker (0306055), with an adapted scraped-surface agitator. Heating begins when the pot is placed over the pre-heated cooker. Within 40 minutes the mass reaches a maximum temperature of 138° C. At the end of the heating cycle, the pot is placed in a 13° C. cooling water bath and the mass is cooled down to under 50° C. Samples were taken during cooking at 14, 20, 25, and 30 min.

### Color Data

| | COLOR | | |
|---|---|---|---|
| SAMPLE | L | a | B |
| INITIAL | 83.51 | −1.21 | 11.22 |
| 14 min | 77.94 | 1.64 | 21.62 |
| 20 min | 66.55 | 7.69 | 28.94 |
| 25 min | 59.80 | 9.65 | 27.26 |
| 30 min | 53.68 | 11.64 | 27.37 |

### Flavor Data

| | | Furfuryl | 2-(5H)- |
|---|---|---|---|
| | Furfural | alcohol | Furanone |
| SAMPLE | ppm | ppm | ppm |
| 14 min | 0.24 | 74.00 | 0.53 |
| 20 min | 1.68 | 117.00 | 2.75 |
| 25 min | 2.13 | 147.00 | 4.03 |
| 30 min | 1.93 | 168.00 | 3.79 |

| | | 2-Hydroxy- | | | |
|---|---|---|---|---|---|
| | | 3-methyl-2- | | Furyl | |
| | Me 2- | cyclopenten- | | hydroxymethyl | |
| | furoate | 1-one | Furaneol | ketone | Maltol |
| SAMPLE | Ppm | ppm | ppm | ppm | ppm |
| 14 min | <0.001 | <0.001 | 0.37 | <0.001 | 20.00 |
| 20 min | <0.001 | <0.001 | 1.15 | 0.21 | 89.00 |
| 25 min | <0.001 | <0.001 | 1.20 | 0.70 | 141.00 |
| 30 min | <0.001 | <0.001 | 0.82 | 1.20 | 200.00 |

### Example—Goat Milk

As used in the examples above and here, various milk products can also be used in the methods of the invention and found in the products of the invention. Dairy milk (“milk” unless a source is identified or the general) and compositions from dairy milk, such as whey protein, anhydrous milk fat, non-fat milk solids, non-fat dry milk, other milk extracts, as was as goat milk, almond milk, soy milk, and other milk-based products available in the art. Generally, these milk products (“milk product” from any source) will contain both protein and sugars. Thus, the milk product can be used alone as the source of protein and sugars for the Maillard reactions discussed here, so that no added sugar is used. However, combinations of various milk products, from whatever source, are also specifically included in the invention, as well as combinations of milk product with added sugars. Any process used to make white chocolate or white coatings could be used. For purposes of this invention, the following ingredients are mixed together in a Globe 20 qt mixer:

| INGREDIENT | g |
|---|---|
| SUCROSE | 2958.00 |
| GOAT WHOLE MILK POWDER | 960.00 |
| COCOA BUTTER | 905.61 |

This composition is mixed for approximately 10 minutes to increase its temperature to 43° C. using a halogen heat lamp. The heated mass is then refined to 20 microns using a Buhler 300 mm 3-roll refiner. After refining, the mixture is conched in a 20 qt Globe mixer for 120 minutes. Keeping the temperature of the mass at 60° C. by a halogen lamp. After 120 minutes, 1134.39 g of cocoa butter and 42 g of soy lecithin are added and mixed for 30 minutes. The final composition of the white chocolate base is as follows:

| INGREDIENT | g |
|---|---|
| SUCROSE | 2958.00 |
| GOAT WHOLE MILK POWDER | 960.00 |
| COCOA BUTTER | 2040.00 |
| SOY LECITHIN | 42.00 |

The white chocolate is transferred to a 20 qt steam-jacketed Groen kettle. The agitator of the kettle was modified for proper mixing. The heating cycle begins when 25 psi steam is applied to the kettle. The mass is cooked for 80 minutes up to a temperature of 118.3° C. Samples of this cooked paste were taken after 30, 40, 50, 60, 70 and 80 min of cooking. Each sample was cooled down using a 10° C. water bath while agitating.

### Color Results

| | COLOR | | |
|---|---|---|---|
| SAMPLE | L* | a* | b* |
| INITIAL | 82.54 | −0.97 | 22.87 |
| 30 min | 76.60 | 3.22 | 32.78 |
| 40 min | 72.73 | 5.48 | 35.48 |
| 50 min | 69.40 | 7.43 | 37.27 |
| 60 min | 65.66 | 8.91 | 38.71 |
| 70 min | 63.12 | 10.03 | 39.41 |
| 80 min- | 60.40 | 11.05 | 40.25 |
| final | | | |

### Flavor Results

| | | Furfuryl | 2-(5H)- |
|---|---|---|---|
| | Furfural | alcohol | Furanone |
| SAMPLE | ppm | ppm | ppm |
| INITIAL | <0.01 | 42 | 0.03 |
| 30 min | 0.33 | 178 | 0.54 |
| 40 min | 0.64 | 219 | 0.91 |
| 50 min | 0.83 | 217 | 1.240 |
| 60 min | 1.05 | 238 | 1.990 |
| 70 min | 0.99 | 240 | 1.990 |
| 80 min-final | 1.55 | 271 | 2.340 |

| | | 2-Hydroxy- | | | |
|---|---|---|---|---|---|
| | | 3-methyl-2- | | Furyl | |
| | Me 2- | cyclopenten- | | hydroxymethyl | |
| | furoate | 1-one | Furaneol | ketone | Maltol |
| SAMPLE | ppm | ppm | ppm | ppm | ppm |
| INITIAL | <0.001 | <0.001 | <0.01 | <0.001 | 27 |
| 30 min | <0.001 | <0.001 | 0.4 | 0.007 | 29 |
| 40 min | <0.001 | <0.001 | 0.61 | 0.030 | 48 |
| 50 min | <0.001 | <0.001 | 0.650 | 0.071 | 71 |
| 60 min | <0.001 | <0.001 | 0.680 | 0.105 | 90 |
| 70 min | <0.001 | <0.001 | 0.680 | 0.164 | 112 |
| 80 min- | <0.001 | <0.001 | 0.700 | 0.171 | 122 |
| final | | | | | |

Example of 400 lbs. White Chocolate Process

As noted above, the white chocolate as used as a starting material in the invention is common to anyone knowledgeable in the art. Any process used to make standard of identity white chocolate, a white chocolate or white chocolate coatings, filings, or creams, or a white chocolate-type food product could be used, for example. For purposes of this invention, the following ingredients are mixed together in a Hobart 140 qt mixer:

Sucrose—200.0 lbs.

Nonfat Dry Milk (NFDM)—68.0 lbs.

Cocoa Butter (CB)—95.9 lbs.

This composition is mixed approximately 10 minutes to increase its temperature to 110° F. using a floor heater. The heated mass is then refined to 20 microns using a Buhler 600 mm 3-roll refiner. After refining, 13.3 pounds cocoa butter is added. This mixture is conched in a 200 gal pug mill for 120 minutes. Temperature of the mass is 130 F-135° F. a closed water loop. After 120 minutes, 20.0 pounds of anhydrous milk fat (AMF) and 2.8 pounds lecithin are added and mixed for 30 minutes. The final composition of the white chocolate base is as follows:

50.0% sucrose

27.3% CB

17.0% NFDM

5.0% AMF

0.7% lecithin

The white chocolate had the following physical properties:

0.60% moisture content

0.13 water activity

5,500 centipoise viscosity at 6.8 s−1 shear rate

Exemplary Caramelization of 400 lbs. White Chocolate Process:

A white chocolate sample (400 lbs., mass temperature 115° F.) is put into a 50-gallon, scraped-surface Lee kettle with dual agitation. The caramel-chocolate process can incorporate a heating-holding under constant agitation-cooling procedure. The heating cycle begins when 25 psi steam is applied to the kettle. The white chocolate mass temperature reaches 235° F. in about 45 minutes and is held at 235° F. for an additional 40 minutes or as indicated. At the end of the heating cycle, 55° F. cooling water is applied and the mass temperature decreases to 130° F. in about 35 minutes. A decrease of one L* value unit is considered the start of flavor and color development. Generally, as known in the art, the fat-based white chocolate product does not mix with water or aqueous phases. Thus, in any aspect of this invention, the methods specifically include the step of avoiding the addition or water or aqueous solutions during the process, including for example, avoiding the use of liquid milk or liquid dairy milk.

Flavor Data from the Above 400 Lbs. Process:

| | | Furfuryl | 2-(5H)- | Methyl 2- |
|---|---|---|---|---|
| TIME | Furfural | alcohol | Furanone | furoate |
| min | ppm | ppm | ppm | ppm |
| 0 | <0.01 | 34 | <0.01 | <0.001 |
| 53 | 0.10 | 33 | 0.26 | <0.001 |
| 62 | 0.56 | 37 | 0.55 | <0.001 |
| 71 | 1.23 | 88 | 1.61 | <0.001 |
| 80 | 2.25 | 117 | 2.73 | <0.001 |
| 89 | 3.04 | 128 | 3.60 | <0.001 |
| End of | 2.71 | 131 | 3.25 | <0.001 |
| cooling | | | | |

| 2-Hydroxy- | | | | |
|---|---|---|---|---|
| 3-methyl- | | | | |
| 2- | | Furyl | | |
| cyclopenten- | | hydroxymethyl | | |
| 1-one | Furaneol | ketone | Maltol | TIME |
| ppm | ppm | ppm | ppm | min |
| <0.001 | <0.001 | <0.001 | 1 | 0 |
| <0.001 | 0.04 | <0.001 | 8 | 53 |
| <0.001 | 0.16 | <0.001 | 24 | 62 |
| <0.001 | 0.38 | 0.054 | 50 | 71 |
| <0.001 | 0.52 | 0.145 | 81 | 80 |
| <0.001 | 0.72 | 0.305 | 113 | 89 |
| 0.004 | 0.47 | 0.442 | 148 | End of |
| | | | | cooling |

Color Data from 400 Pound Process:

| | COLOR | | |
|---|---|---|---|
| Time | L* | a* | b* |
| 0 min | 80.02 | −0.24 | 19.03 |
| 53 min | 78.73 | −0.13 | 23.38 |
| 62 min | 75.63 | 1.79 | 26.63 |
| 71 min | 72.12 | 4.37 | 29.44 |
| 80 min | 67.56 | 6.61 | 30.69 |
| 89 min | 63.48 | 8.70 | 31.44 |
| End of | 62.00 | 9.54 | 30.56 |
| cooling | | | |

Example of 100 lbs. White Chocolate Process

The white chocolate used in the invention is common to anyone knowledgeable in the art. Any process used to make white chocolate or white coatings could be used. For purpose of this invention, the following ingredients are mixed together in a Hobart 60 qt mixer:

Sucrose—45.0 lbs.

Nonfat Dry Milk (NFDM)—17.0 lbs.

Lactose—5.0 lbs.

Cocoa Butter (CB)—23.0 lbs.

This composition is mixed approximately 10 minutes to increase its temperature to 110° F. using a floor heater. The heated mass is then refined to 20 microns using a Buhler 600 mm 3-roll refiner. After refining, 3.3 pounds cocoa butter is added. This mixture is conched in a 20 gal pug mill for 120 minutes. Temperature of the mass is 130 F-135° F. a closed water loop. After 120 minutes, 5 pounds of anhydrous milk fat (AMF) and 0.7 pounds lecithin are added and mixed for 30 minutes. The final composition of the white chocolate base is as follows:

45.0% sucrose

27.3% CB

17.0% NFDM

5.0% AMF

0.7% lecithin

The white chocolate had the following physical properties:

0.60% moisture content

0.13 water activity

5,500 centipoise viscosity at 6.8 s−1 shear rate

Exemplary Caramelization of 100 lbs. White Chocolate Process:

A white chocolate sample (100 lbs., mass temperature 105° F.) is put into a 15-gallon, scraped-surface Lee kettle with dual agitation. The caramel-chocolate process can incorporate a heating-holding under constant agitation-cooling procedure. The heating cycle begins when 25 psig steam is applied to the kettle. The white chocolate mass temperature reaches 235° F. in about 40 minutes, 246° F. in 60 minutes and is held at 246° F. for an additional 20 minutes or as indicated. At the end of the heating cycle, 55° F. cooling water is applied and the mass temperature decreases to 130° F. in about 20 minutes. A decrease of one L* value unit is considered the start of flavor and color development.

Flavor Data from the Above 100 Lbs. Process:

| | | Furfuryl | 2-(5H)- | Methyl 2- |
|---|---|---|---|---|
| TIME | Furfural | alcohol | Furanone | furoate |
| mins | ppm | ppm | ppm | ppm |
| 0 | <0.01 | 34 | <0.01 | <0.001 |
| 40 | 0.17 | 37 | 0.19 | <0.001 |
| 50 | 0.65 | 70 | 1.11 | <0.001 |
| 60 | 1.96 | 144 | 1.90 | <0.001 |
| 80 | 4.71 | 186 | 6.26 | <0.001 |

| 2-Hydroxy- | | | | |
|---|---|---|---|---|
| 3-methyl- | | | | |
| 2- | | Furyl | | |
| cyclopenten- | | hydroxymethyl | | |
| 1-one | Furaneol | ketone | Maltol | TIME |
| ppm | ppm | ppm | ppm | mins |
| <0.001 | <0.001 | <0.001 | 1 | 0 |
| <0.001 | 0.14 | <0.001 | 13 | 40 |
| <0.001 | 0.45 | 0.032 | 60 | 50 |
| <0.001 | 0.67 | 0.332 | 149 | 60 |
| 0.034 | 0.93 | 1.990 | 301 | 80 |

Color Data from the 100 Lbs

| | COLOR | | |
|---|---|---|---|
| Time | L* | a* | b* |
| 0 min | 80.02 | −0.24 | 19.03 |
| 40 min | 78.06 | 0.355 | 24.085 |
| 50 min | 71.43 | 4.49 | 28.56 |
| 60 min | 60.71 | 9.975 | 30.17 |
| 80 min | 48.50 | 12.37 | 24.23 |

Comparative flavor data from existing commercial products. In contrast to the products made from the methods of this invention, the existing commercial products and traditional white chocolate production methods have a limited ability to vary the color and flavor markers. The data below summarizes exemplary commercial products.

| | | Furfuryl | 2-(5H)- | Methyl |
|---|---|---|---|---|
| | Furfural | alcohol | Furanone | 2-furoate |
| | ppm | ppm | ppm | ppm |
| Nestle | 0.30 | 28 | 0.79 | <0.001 |
| Caramac | | | | |
| Valrhona | 0.64 | 228 | 1.06 | <0.001 |
| Dulcey | | | | |

| 2-Hydroxy-3- | | | | |
|---|---|---|---|---|
| methyl-2- | | Furyl | | |
| cyclopenten- | | hydroxymethyl | | |
| 1-one | Furaneol | ketone | Maltol | |
| ppm | ppm | ppm | ppm | |
| <0.001 | 0.04 | <0.001 | 293 | Nestle |
| | | | | Caramac |
| 0.010 | 0.08 | 0.063 | 44 | Valrhona |
| | | | | Dulcey |

Color Data from Comparative Commercial Products:

| | COLOR | | |
|---|---|---|---|
| Time | L* | a* | b* |
| Nestle | 72.22 | 5.30 | 24.13 |
| Caramac | | | |
| Valrhona | 63.00 | 7.48 | 25.96 |
| Dulcey | | | |

Flavor descriptors: As used in the art, the flavor markers referred to above and in this invention are generally described. The Table below list the representative descriptions of certain flavor markers.

| Compound | Descriptor |
|---|---|
| Furfural | bready, sweet, almond, fragrant, baked bread, |
| | brown, woody, nutty, caramelic |
| | almond, woody, sweet |
| Furfuryl Alcohol | bready, musty, sweet, brown caramellic, coffee |
| | alcoholic, chemical, sufuraceous, estery |
| | burnt, sweet, caramellic, brown |
| | burnt, coffee, oily, whiskey |
| | mild, warm oily, burnt |
| 2[5H]-Furanone | buttery |
| Furaneol | caramellic, sweet, cotton candy, caramel |
| | strawberry, sugar, slight burnt, brown |
| | strawberry, sweet, caramel |
| | fruity, caramel, burnt pineapple |
| 2-Furyl hydroxymethyl | natural occurrence in strawberry jam and chicory |
| ketone | root extract |
| Maltol | sweet, caramel, cotton candy, jam, fruity, baked |
| | bread |
| | sweet, cotton candy, caramellic, jammy, fruity, |
| | berry |
| | caramel, sweet, jam |
| | warm, sweet, fruity, jam |

As shown in the data above and in the Figures, using the method of the invention one of skill in the art can produce a white chocolate-type food product or ingredient that possesses a desired flavor profile that differs from existing white chocolate products available. As used herein, white chocolate-type food product, and chocolate-type food product, refers to products that contain the ingredients generally used for white chocolate and chocolate under the U.S. standard of identity, but they do not necessarily comply with all the limits for all ingredients listed in the standard of identity for white chocolate or chocolate. Thus, while standard of identity white chocolate and chocolate can be made from the methods of the invention, and those products are specifically included in this invention, products falling outside the standard of identity are also specifically included in the invention. One of skill in the art is familiar with the standard if identity for various cocoa solids and cocoa butter containing food products under U.S. rules. While the flavor markers 2-Hydroxy-3-methyl-2-cyclopenten-1-one (MCP) and Methyl 2-furoate are discussed preferentially here, other flavor markers or components shown in the data above or in the Figures, such as the chromatographs of FIGS. 7-10, can be used to produce a novel food product according to the invention. Thus, a food product, white chocolate or white chocolate-type product of the invention can differ in its content of flavor markers from the comparative commercially available samples can be produced by varying the heating time and the temperature used for the Maillard reaction. Similarly, the final color of the food product or white chocolate-type food product can be varied. The preferred ranges of some of the flavor markers and the color of the final white chocolate-type food products are listed in the tables below.

| | | Furfuryl | 2(5H)- |
|---|---|---|---|
| | Furfural | alcohol | Furanone |
| | ppm | ppm | ppm |
| Range | 0.7-20.00 | 30-220 | 1.2-20.00 |
| Preferred | 2.50-5.00 | 130-180 | 3.50-6.00 |

| | | Furyl | |
|---|---|---|---|
| | | hydroxymethyl | |
| | Furaneol | ketone | Maltol |
| ppm | ppm | ppm | ppm |
| Range | 0.100-10.000 | 0.001-10.000 | 50-280 |
| Preferred | 0.800-2.000 | 0.400-2.000 | 130-230 |

| | COLOR | | |
|---|---|---|---|
| | L* | a* | b* |
| Range | 80-45 | 8-16.00 | 26-40.00 |
| Preferred | 66-56 | 9-13.00 | 28-32.00 |

The examples presented above and the contents of the application define and describe examples of the many combinations, food products or ingredients, and methods that can be produced or used according to the teachings herein. None of the examples and no part of the description should be taken as a limitation on the scope of the inventions herein as a whole, or of the meaning of the following claims.

What is claimed is:

1. A method of producing a caramelized white chocolate-type food product comprising mixing a white chocolate-type product with lecithin to reach a total lecithin concentration above 0.5% wt, mixing and heating the resulting mixture to 180° F. (82° C.) or higher for a selected amount of time, followed by cooling the mixture, wherein the time selected at the temperature used produces a caramelized flavor and color that lacks detectable levels of the flavor component 2-Hydroxy-3-methyl-2-cyclopenten-1-one within 24 hours after cooling.

2. The method of claim 1 wherein the product further lacks the flavor component methyl 2-furoate.

3. The method of claim 1, wherein over 1% wt total lecithin is used.

4. The method of claim 1, wherein heating occurs to a temperature of 200° F. or above.

5. The method of claim 4, further comprising monitoring the L* value of the mixture during heating in order to select the length of time at the temperature of 200° F. or above.

6. The method of claim 1, wherein soya lecithin is used as the lecithin.

7. The method of claim 1, wherein no food coloring agents or brown sugar are added.

8. The method of claim 7, wherein the color selected for the food product is substantially determined by the length of time at the temperature used during heating in a Maillard reaction.

9. A method of producing a caramelized white chocolate-type food product comprising mixing a white chocolate-type product with an added emulsifier, heating the resulting mixture to greater than 200° F. (93° C.) for a selected amount of time and optionally under constant agitation, followed by cooling the mixture,
wherein the food product contains caramelized flavor and color components as a result of a Maillard reaction between the proteins and sugars present, and the food product lacks detectable levels of the flavor component 2-Hydroxy-3-methyl-2-cyclopenten-1-one within 24 hours of cooling, or lacks both 2-hydroxy-3-methyl-2-cyclopenten-1-one and methyl 2-furoate.

10. The method of claim 9 wherein the selected amount of time is from about 10 minutes to about 80 minutes.

11. The method of claim 9, wherein the selected amount of time is longer than 30 minutes.

12. The method of claim 9, wherein the temperature is about 250° F.

13. The method of claim 11, wherein the temperature is about 250° F.

14. The method of claim 9, wherein sugar is present in the product at about 30-55 wt %.

15. A confectionary food product produced from the method of claim 1 containing no detectable amount of the flavor component 2-Hydroxy-3-methyl-2-cyclopenten-1-one.

16. A confectionary food product as claimed in claim 15, wherein the differential secondary protein structure of the protein present in the product as compared to white chocolate is detectable as an IR shift in the amino acid side chain peaks.

17. A method of producing a caramelized food product containing one or more flavor components 2-acetyl furan and 2-acetyl-3-hydroxy furan, but is lacking detectable amounts of the flavor components 2-hydroxy-3-methyl-2-cyclopenten-1-one and methyl 2-furoate, comprising heating a milk chocolate or white chocolate product to above 200° F. for a selected amount of time, and thereafter cooling the product.

18. The method of claim 17, wherein the temperature is 220° F.

19. The method of claim 17, further comprising adding a reducing sugar.

20. The method of claim 19, wherein the reducing sugar is selecting from one or more of fructose, dextrose, maltose, galactose, glucose, glyceraldehyde, lactose, ribose, xylose, arabinose, aldopentoses, and any other reducing sugar.

21. The method of claim 17, further comprising increasing the pH of the mixture.

22. The method of claim 21, wherein one or more of disodium phosphate, sodium bicarbonate, and sodium carbonate is added to increase the pH.

23. The method of claim 1 or 17, wherein sugar is present at about 30-55 wt %.

24. The method of claim 17, further comprising adding one or more of cocoa solids or a cocoa extract.

25. A method of producing a caramelized white chocolate-type food product according to claim 17, further comprising mixing a white chocolate-type food product containing ribose adding an emulsifier, mixing and then heating the mixture to above 40° C. for a selected amount of time in order for a Maillard reaction to develop a desired color and flavor profile, wherein the product lacks detectable amounts of the flavor components 2-hydroxy-3-methyl-2-cyclopenten-1-one and methyl 2-furoate, and cooling the product.

26. A method of producing a caramelized chocolate-type food product or ingredient according to claim 17, further comprising providing a dry milk product, adding cocoa butter or an edible fat, adding an emulsifier, avoiding added sugar, mixing and then heating the mixture to above 90° C. for a selected amount of time in order for a Maillard reaction to develop a desired color and flavor profile, wherein the product lacks detectable amounts of the flavor components 2-hydroxy-3-methyl-2-cyclopenten-1-one and methyl 2-furoate, and cooling the product.

27. A caramelized white chocolate-type food product or ingredient of claim 15, lacking detectable amounts of the flavor components 2-hydroxy-3-methyl-2-cyclopenten-1-one and further lacking flavor component methyl 2-furoate, the product containing one or more of the following flavor components and within the concentration range given: Furfural (2.5 to 5 ppm); Furfuryl alcohol (130 to 180 ppm); 2-(5H)-Furanone (3.5 to 6 ppm); Furaneol (0.8 to 2 ppm); Furyl hydroxymethyl ketone (0.4 to 2 ppm); and Maltol (130 to 230 ppm).

28. A caramelized white chocolate-type food product or ingredient of claim 15, lacking detectable amounts of the flavor components 2-hydroxy-3-methyl-2-cyclopenten-1-one and further lacking flavor component methyl 2-furoate, the product containing one or more of the following flavor components and within the concentration range given: Furfural (0.7 to 20 ppm); Furfuryl alcohol (30 to 220 ppm); 2-(5H)-Furanone (1.2 to 20 ppm); Furaneol (0.1 to 10 ppm); Furyl hydroxymethyl ketone (0.001 to 10 ppm); and Maltol (50 to 280 ppm).

29. The food product or ingredient of claim 27, wherein the color attributes fall within the following range: an L* value of 66 to 56; an a* value of 9 to 13; and a b* value of 28 to 32.

30. The food product or ingredient of claim 27, wherein the color attributes fall within the following range: an L* value of 80 to 45; an a* value of 8 to 16; and a b* value of 26 to 40.

31. The method of claim 1, wherein the white chocolate-type food product used contains any edible fat or combination of edible fats.

32. The method of claim 29, wherein the white chocolate-type food product used contains no cocoa butter.

33. A method of producing a caramelized white chocolate-type food product of claim 1, further comprising mixing a protein or amino acid source with a sugar, adding cocoa butter or an edible fat, adding lecithin to above 0.5% wt, mixing and heating the resulting mixture to 180° F. (82° C.) or higher for a selected amount of time, followed by cooling the mixture, wherein the time selected at the temperature used produces a caramelized flavor and color that lacks detectable levels of the flavor component 2-Hydroxy-3-methyl-2-cyclopenten-1-one within 24 hours after cooling.

34. The method of claim 33 wherein the product further lacks the flavor component methyl 2-furoate.

35. The method of claim 33, wherein over 1% wt lecithin is used.

36. The method of claim 33, wherein heating occurs to a temperature of 200° F. or above.

37. The method of claim 36, further comprising monitoring the L* value of the mixture during heating in order to select the length of time at the temperature of 200° F. or above.

38. The method of claim 33, wherein soya lecithin is used as the lecithin.

39. The method of claim 33, wherein no food coloring agents or brown sugar are added.

40. The method of claim 39, wherein the color selected for the food product is substantially determined by the length of time at the temperature used during heating in a Maillard reaction.

41. The method of claim 33, further comprising adding a cocoa solids containing ingredient.

42. A confectionary food product produced from the method of claim 33 containing no detectable amount of the flavor component 2-Hydroxy-3-methyl-2-cyclopenten-1-one.

43. A confectionary food product as claimed in claim 42, wherein the differential secondary protein structure of the protein present in the product as compared to white chocolate is detectable as an IR shift in the amino acid side chain peaks.
